(19) United States
(12) Patent Application Publication
(10) Pub. No.: US 2025/0001848 A1
(43) Pub. Date: Jan. 2, 2025

(54) SUNROOF DEVICE

(71) Applicant: AISIN CORPORATION, Kariya-shi (JP)

(72) Inventors: Yusuke SAKATA, Kariya-shi (JP); Aisei KAWAZU, Kariya-shi (JP)

(73) Assignee: AISIN CORPORATION, Kariya-shi (JP)

(21) Appl. No.: 18/756,460

(22) Filed: Jun. 27, 2024

(30) Foreign Application Priority Data
Jun. 29, 2023 (JP) 2023-106922

(51) Int. Cl. B60J 7/043; B60J 7/057

(52) U.S. Cl. CPC B60J 7/043; B60J 7/0573

(57) ABSTRACT

A power transmission member includes a check rotating about an axis extending in a long-side direction of a guide unit, between an engagement position at which power can be transmitted from a driving shoe to a rear support portion and a release position at which power cannot be transmitted from the driving shoe to the rear support portion. The guide unit includes an inner side sliding surface causing the check to rotate from the engagement position toward the release position by sliding with the check when the driving shoe moves rearward toward a tilt-up corresponding position. The driving shoe includes an outer side sliding surface causing the check to rotate from the release position toward the engagement position by sliding with the check when the driving shoe moves forward from the tilt-up corresponding position.

### CROSS REFERENCE TO RELATED APPLICATIONS

This application is based on and claims priority under 35 U.S.C. § 119 to Japanese Patent Application 2023-106922, filed on Jun. 29, 2023, the entire content of which is incorporated herein by reference.

### TECHNICAL FIELD

This disclosure generally relates to a sunroof device.

### BACKGROUND DISCUSSION

In JP2016-007931A (Reference 1), a vehicle including a sunroof device is described. The sunroof device includes a movable panel that opens and closes a roof opening portion, guide rails that extend in a front-rear direction, and driving shoes that move in the front-rear direction along the guide rails. The sunroof device also includes functional brackets that are fixed to the movable panel, rear support portions that support the functional brackets, and checks that change a status of power transmission from the driving shoes to the rear support portions.

The movable panel operates among a full-close position at which the roof opening portion is fully closed, a tilt-up position at which a rear end portion ascends higher than at the full-close position, and a full-open position at which the roof opening portion is fully opened. Each of the functional brackets includes a guide pin that slides with one of the guide rails, on a front end portion. The functional brackets cause, by moving in the front-rear direction along the guide rails, based on power to be transmitted from the driving shoes, the movable panel to operate between the tilt-up position and the full-open position. The rear support portions support portions of the functional brackets on a rear side of the guide pins. The rear support portions cause, by rotating about axes extending in a width direction, based on power to be transmitted from the driving shoes, the movable panel to operate between the full-close position and the tilt-up position. The checks transmit, when the movable panel operates between the full-close position and the tilt-up position, power from the driving shoes to the rear support portions and, when the movable panel operates between the tilt-up position and the full-open position, do not transmit power from the driving shoes to the rear support portions.

In the sunroof device as described above, the checks generally change a status of power transmission from the driving shoes by moving in an up-down direction of the vehicle. Specifically, for the sunroof device as described above, it is necessary to secure a moving range for the checks to move in the up-down direction. In other words, room for improvement remains in making the sunroof device as described above thinner in the up-down direction.

A need thus exists for a sunroof device, which is not susceptible to the drawback mentioned above.

### SUMMARY

A sunroof device includes: a movable panel that operates among a full-close position at which a roof opening portion of a vehicle is fully closed, a tilt-up position at which a rear end portion ascends higher than at the full-close position, and a full-open position that is a position located on a rear side of the tilt-up position and at which the roof opening portion is fully opened; a guide unit that extends in a front-rear direction; a front support portion that supports the movable panel; a rear support portion that supports the movable panel on a rear side of the front support portion; a driving shoe that, by moving along the guide unit, drives the front support portion and the rear support portion; and a power transmission member that, when the movable panel operates between the full-close position and the tilt-up position, transmits power from the driving shoe to the rear support portion and, when the movable panel operates between the tilt-up position and the full-open position, does not transmit power from the driving shoe to the rear support portion, the movable panel performs, when the driving shoe moves rearward, an opening operation from the full-close position to the full-open position via the tilt-up position and performs, when the driving shoe moves forward, a closing operation from the full-open position to the full-close position via the tilt-up position, the front support portion causes the movable panel to move in the front-rear direction, based on power to be transmitted from the driving shoe, the rear support portion causes, by causing a rear end portion of the movable panel to ascend or descend based on power to be transmitted from the driving shoe via the power transmission member, the movable panel to operate between the full-close position and the tilt-up position, the power transmission member includes a check that rotates about an axis extending in a long-side direction of the guide unit between an engagement position at which power can be transmitted from the driving shoe to the rear support portion and a release position at which power cannot be transmitted from the driving shoe to the rear support portion, and, when a position of the driving shoe when the movable panel is located at the tilt-up position is defined as a tilt-up corresponding position, at least one of the guide unit and the driving shoe includes a sliding surface that causes the check to rotate from one position of the engagement position and the release position toward another position by sliding with the check when the driving shoe moves rearward toward the tilt-up corresponding position or when the driving shoe moves forward from the tilt-up corresponding position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a schematic configuration of a vehicle including a sunroof device;

FIG. 2 is a plan view illustrating the schematic configuration of the vehicle including the sunroof device;

FIG. 3 is a perspective view of a front side portion of the sunroof device;

FIG. 4 is an exploded perspective view of the front side portion of the sunroof device;

FIG. 5 is an exploded perspective view of a guide unit of the sunroof device;

FIG. 6 is a side view of an inner side front guide of the guide unit;

FIG. 7 is another exploded perspective view of the front side portion of the sunroof device;

FIG. 8 is still another exploded perspective view of the front side portion of the sunroof device;

FIG. 9 is still another exploded perspective view of the front side portion of the sunroof device;

FIG. 10 is a side view of a driving shoe of the sunroof device;

FIG. 11 is an exploded perspective view of a rear side portion of the sunroof device;

FIG. 12 is another exploded perspective view of the rear side portion of the sunroof device;

FIG. 13 is still another exploded perspective view of the rear side portion of the sunroof device;

FIG. 14 is a side view of a front side portion of a power transmission member of the sunroof device;

FIG. 15 is another side view of the front side portion of the power transmission member of the sunroof device;

FIG. 16 is a side view of the sunroof device when a movable panel is located at a full-close position;

FIG. 17 is a side view of the sunroof device when the movable panel is located at a tilt-up position;

FIG. 18 is a side view of the sunroof device when the movable panel is located at a lift-up position;

FIG. 19 is a side view of the sunroof device when the movable panel is located at a full-open position;

FIG. 20 is a cross-sectional view taken along the arrow line A-A in FIG. 16;

FIG. 21 is a cross-sectional view taken along the arrow line B-B in FIG. 20;

FIG. 22 is a cross-sectional view taken along the arrow line C-C in FIG. 20;

FIG. 23 is a cross-sectional view of the sunroof device taken along the arrow line B-B;

FIG. 24 is a cross-sectional view of the sunroof device taken along the arrow line C-C;

FIG. 25 is another cross-sectional view of the sunroof device taken along the arrow line B-B;

FIG. 26 is another cross-sectional view of the sunroof device taken along the arrow line C-C;

FIG. 27 is a cross-sectional view taken along the arrow line A-A in FIG. 17;

FIG. 28 is a cross-sectional view taken along the arrow line B-B in FIG. 27;

FIG. 29 is a cross-sectional view taken along the arrow line C-C in FIG. 27;

FIG. 30 is still another cross-sectional view of the sunroof device taken along the arrow line C-C;

FIG. 31 is still another cross-sectional view of the sunroof device taken along the arrow line C-C;

FIG. 32 is still another cross-sectional view of the sunroof device taken along the arrow line B-B;

FIG. 33 is still another cross-sectional view of the sunroof device taken along the arrow line C-C;

FIG. 34 is still another cross-sectional view of the sunroof device taken along the arrow line B-B;

FIG. 35 is still another cross-sectional view of the sunroof device taken along the arrow line C-C;

FIG. 36 is still another cross-sectional view of the sunroof device taken along the arrow line B-B; and

FIG. 37 is still another cross-sectional view of the sunroof device taken along the arrow line C-C.

### DETAILED DESCRIPTION

An embodiment of a sunroof device disclosed here is described.

### <Configuration of Present Embodiment>

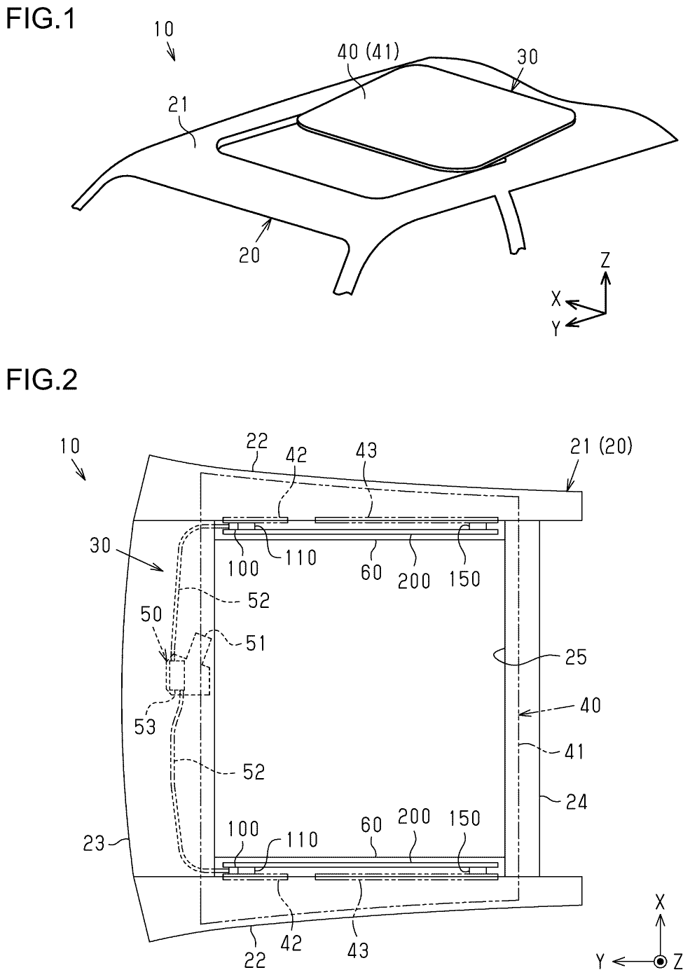

As illustrated in FIG. 1, a vehicle 10 includes a vehicle body 20 and a sunroof device 30. In the drawings, a direction in which the X-axis extends indicates the width direction of the vehicle 10, a direction in which the Y-axis extends indicates the front-rear direction of the vehicle 10, and a direction in which the Z-axis extends indicates the up-down direction of the vehicle 10. In the following description, the width direction of the vehicle 10, the front-rear direction of the vehicle 10, and the up-down direction of the vehicle 10 are referred to as a width direction, a front-rear direction, and an up-down direction, respectively. In addition, in the width direction, a direction separating from the center of the vehicle 10 is refer to as an outward direction, and a direction coming close to the center of the vehicle 10 is referred to as an inward direction.

### <Vehicle Body 20>

As illustrated in FIG. 2, a vehicle body 20 includes a roof structure 21 that constitutes a roof. The roof structure 21 includes two side panels 22 that extend in the front-rear direction, a front panel 23 that connects front edges of the two side panels 22 to each other, and a rear panel 24 that connects rear ends of the two side panels 22 to each other. In addition, the roof structure 21 includes a roof opening portion 25 that is demarcated by the two side panels 22, the front panel 23, and the rear panel 24. The roof opening portion 25 is formed in, when viewed in plan from the upper side, a rectangular shape having the long-side direction and the short-side direction aligned with the width direction and the front-rear direction, respectively.

### <Sunroof Device 30>

As illustrated in FIG. 2, the sunroof device 30 includes a movable panel 40, an actuator 50, two guide units 60, two driving shoes 100, two front support portions 110, two rear support portions 150, and two power transmission members 200. Many of the constituent components of the sunroof device 30 are not only formed in bilaterally symmetric shapes but also arranged on the right-hand side and the left-hand side of the roof opening portion 25. Thus, in the following description, with regard to bilaterally symmetric constituent components, a constituent component arranged on the right-hand side of the sunroof device 30 is described.

### <Movable Panel 40>

As illustrated in FIG. 2, the movable panel 40 includes a panel body 41, two front brackets 42, and two rear brackets 43.

The panel body 41 is formed of a material that can transmit light, such as glass and resin. The panel body 41 has a size and a shape matching the roof opening portion 25. The two front brackets 42 are located on the front side of the two rear brackets 43. The two front brackets 42 are respectively located on both sides in the width direction of the panel body 41. Likewise, the two rear brackets 43 are respectively located on both sides in the width direction of the panel body 41. The two front brackets 42 and the two rear brackets 43 are bonded on a lower surface of the panel body 41.

### <Actuator 50>

The actuator 50 includes an electric motor 51, two cables 52 that is driven by the electric motor 51, and a conversion mechanism 53 that converts rotational motion of an output shaft of the electric motor 51 to back-and-forth motion of the cables 52. The electric motor 51 and the conversion mechanism 53 are fixed to a central portion in the width direction of the front panel 23. The cables 52 are push-pull cables that can push and pull the driving shoes 100. The cables 52 are wired along the front panel 23 and the guide units 60.

### <Guide Unit 60>

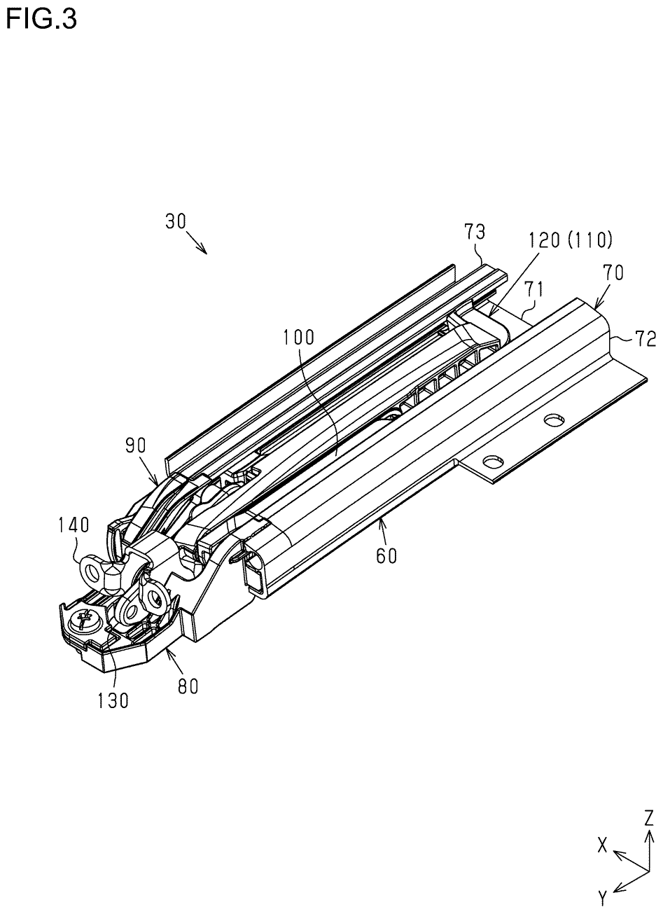

As illustrated in FIGS. 3 to 5, each of the guide units 60 includes a guide rail 70, an inner side front guide 80, and an outer side front guide 90.

The guide rail 70 has a long-side direction aligned with the front-rear direction. The guide rail 70 curves in such a manner that when viewed from a side in the width direction, a central portion in the long-side direction is located higher than both ends in the long-side direction. In the present embodiment, examples of the guide rail 70 that extends in the front-rear direction include not only a guide rail 70 extending in a linear shape but also a guide rail 70 extending while curving.

In the following description, the long-side direction of the guide rail 70 is referred to as “first reference direction”, and a direction orthogonal to both the first reference direction and the width direction is referred to as “second reference direction”. When the guide rail 70 curves, a tangential direction of the guide rail 70 corresponds to the first reference direction, and a normal direction of the guide rail 70 corresponds to to the second reference direction. In other words, when the guide rail 70 curves, each of the first reference direction and the second reference direction points in a different direction depending on a position on the guide rail 70. The guide rail 70 is formed by extruding a metallic material, such as aluminum.

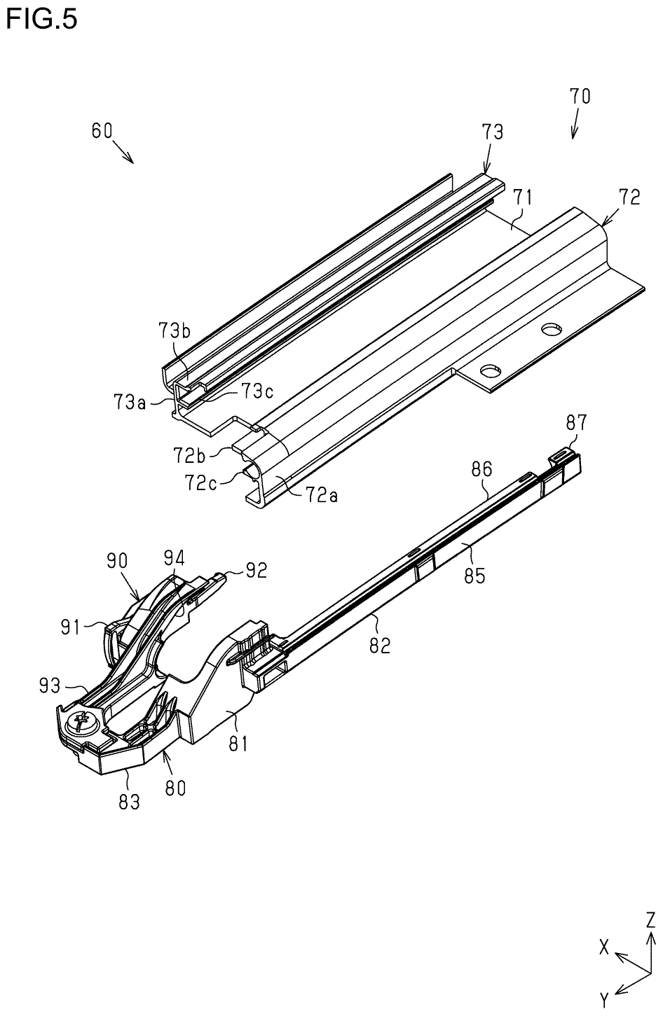

As illustrated in FIG. 5, the guide rail 70 includes a bottom wall 71, an inner wall 72, and an outer wall 73. The bottom wall 71 is formed in a flat plate shape having the long-side direction and the short-side direction aligned with the first reference direction and the width direction, respectively. The inner wall 72 extends from a position closer to an inner side edge than to an outer side edge in the width direction of the bottom wall 71. The inner wall 72 includes a first inner wall 72a that extends upward from the bottom wall 71, a second inner wall 72b that extends outward in the width direction from a top edge of the first inner wall 72a, and a third inner wall 72c that extends outward in the width direction from a lower position than the second inner wall 72b on the first inner wall 72a. The outer wall 73 extends from a position closer to the outer side edge than to the inner side edge in the width direction of the bottom wall 71. The outer wall 73 includes a first outer wall 73a that extends upward from the bottom wall 71, a second outer wall 73b that extends inward in the width direction from a top edge of the first outer wall 73a, and a third outer wall 73c that extends inward in the width direction from a lower position than the second outer wall 73b on the first outer wall 73a.

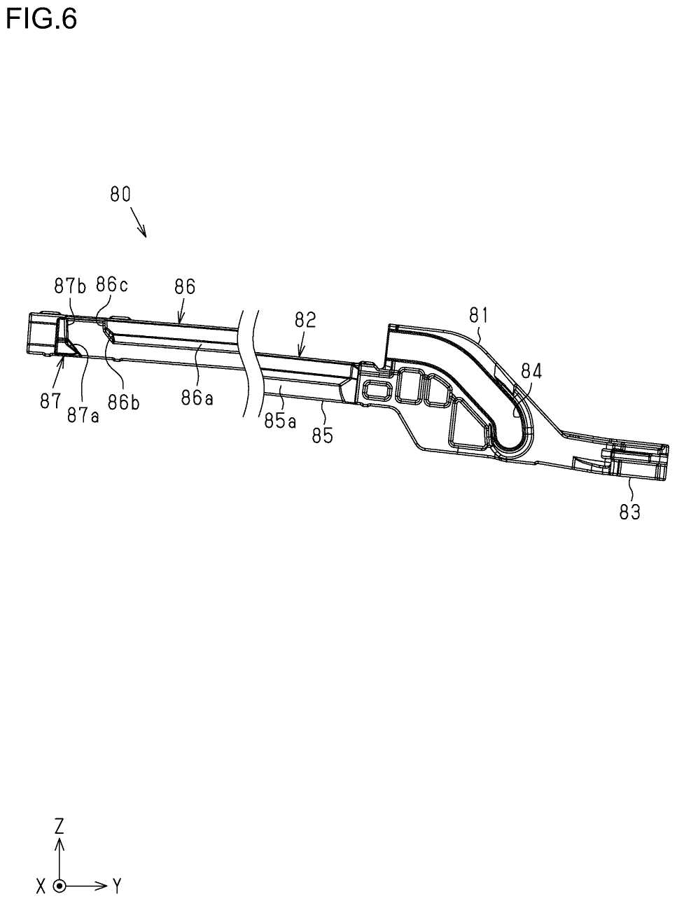

As illustrated in FIGS. 5 and 6, the inner side front guide 80 includes an extension portion 81 that forms a front end portion of the guide unit 60, an insertion portion 82 that is inserted into the guide rail 70, and a joint portion 83 that is joined to the outer side front guide 90. The extension portion 81 includes a guide groove 84 that extends upward toward the rear. The guide groove 84 has a depth direction aligned with the width direction.

As illustrated in FIG. 6, the insertion portion 82 extends rearward from the extension portion 81. The insertion portion 82 includes a side wall 85 that has a plate thickness direction aligned with the width direction and a first inner side engaging wall 86 and a second inner side engaging wall 87 that project outward in the width direction from the side wall 85. A surface of the side wall 85 that faces outward in the width direction is formed in a curved surface 85a that protrudes outward in the width direction.

In the first reference direction, length of the first inner side engaging wall 86 is less than length of the side wall 85. A front edge of the first inner side engaging wall 86 is aligned with a front edge of the side wall 85. On the other hand, a rear end of the first inner side engaging wall 86 is located on the front side of a rear end of the side wall 85. A lower edge of the first inner side engaging wall 86 is located above a lower edge of the side wall 85.

The first inner side engaging wall 86 includes an inner side restricting surface 86a, an inner side auxiliary sliding surface 86b, and an inner side clamping surface 86c that cross a projecting direction of the first inner side engaging wall 86 with respect to the side wall 85. The inner side restricting surface 86a is a surface that crosses the second reference direction and that extends along the first reference direction. The inner side auxiliary sliding surface 86b crosses both the first reference direction and the second reference direction. Specifically, the inner side auxiliary sliding surface 86b is inclined upward toward the rear. A front edge of the inner side auxiliary sliding surface 86b is connected to a rear edge of the inner side restricting surface 86a. The inner side clamping surface 86c extends in the second reference direction. The inner side clamping surface 86c preferably crosses the first reference direction at an angle close to the right angle. A lower edge of the inner side clamping surface 86c is connected to a rear edge of the inner side auxiliary sliding surface 86b.

The second inner side engaging wall 87 projects from a rear end portion of the side wall 85. The second inner side engaging wall 87 is located on the rear side of the first inner side engaging wall 86. The second inner side engaging wall 87 includes an inner side sliding surface 87a and an inner side clamping surface 87b that cross a projecting direction of the second inner side engaging wall 87 with respect to the side wall 85. The inner side sliding surface 87a crosses both the first reference direction and the second reference direction. Specifically, the inner side sliding surface 87a is inclined upward toward the rear. The inner side clamping surface 87b extends in the second reference direction. The inner side clamping surface 87b preferably crosses the first reference direction at an angle close to the right angle. A lower edge of the inner side clamping surface 87b is connected to a rear edge of the inner side sliding surface 87a.

The inner side auxiliary sliding surface 86b of the first inner side engaging wall 86 and the inner side sliding surface 87a of the second inner side engaging wall 87 face each other. Likewise, the inner side clamping surface 86c of the first inner side engaging wall 86 and the inner side clamping surface 87b of the second inner side engaging wall 87 face each other. The first inner side engaging wall 86 corresponds to a “second restricting portion”, the inner side auxiliary sliding surface 86b corresponds to a “second auxiliary sliding surface”, and the inner side clamping surface 86c corresponds to a “clamping portion”. The inner side sliding surface 87a corresponds to a “sliding surface” and a “first sliding surface”, and the inner side clamping surface 87b corresponds to the “clamping portion”.

As illustrated in FIG. 5, the outer side front guide 90 includes an extension portion 91 that forms the front end portion of the guide unit 60, an insertion portion 92 that is inserted into the guide rail 70, and a joint portion 93 that is joined to the inner side front guide 80. The extension portion 91 includes a guide groove 94 that extends upward toward the rear. The guide groove 94 has a depth direction aligned with the width direction. In the first reference direction, length of the insertion portion 92 is set to be extremely shorter than length of the insertion portion 82 of the inner side front guide 80.

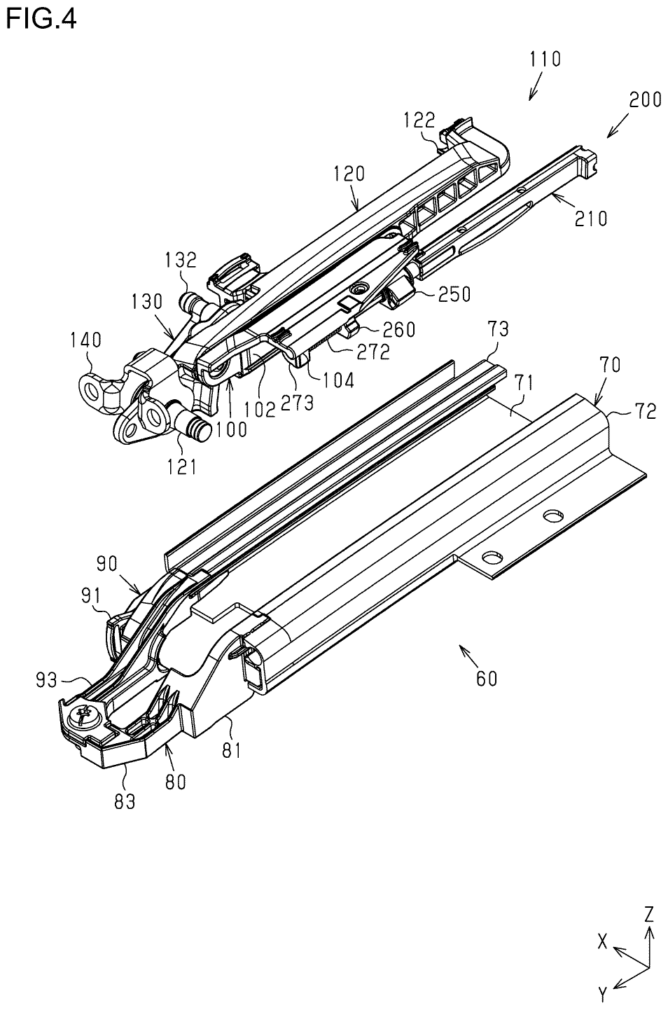

As illustrated in FIGS. 4 and 5, the joint portion 83 of the inner side front guide 80 and the joint portion 93 of the outer side front guide 90 are joined by a fastening member, such as a screw and a bolt. Thus, the inner side front guide 80 and the outer side front guide 90 are integrated into one front guide. The insertion portion 82 of the inner side front guide 80 and the insertion portion 92 of the outer side front guide 90 are inserted into a front end portion of the guide rail 70. In this manner, the guide groove 84 of the inner side front guide 80 is connected to a space between the second inner wall 72b and the third inner wall 72c of the guide rail 70. On the other hand, the guide groove 94 of the outer side front guide 90 is connected to a space between the second outer wall 73b and the third outer wall 73c of the guide rail 70.

As illustrated in FIG. 2, the guide units 60 are fixed to the vehicle body 20 in such a manner as to be adjacent to the side panels 22. In this manner, the guide units 60 extend in the front-rear direction on both sides in the width direction of the roof opening portion 25.

### <Driving Shoe 100>

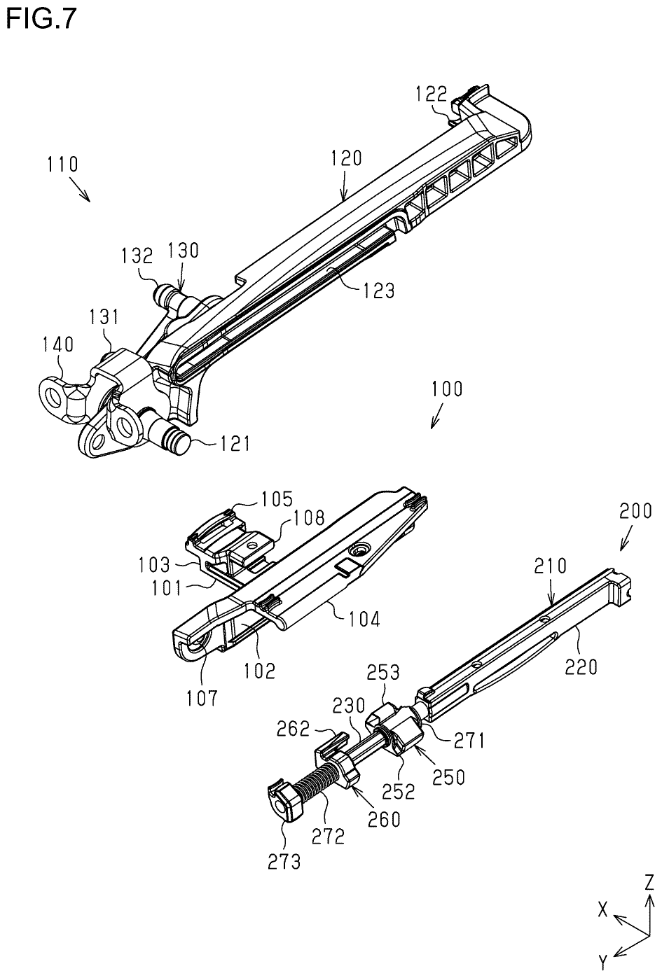

As illustrated in FIGS. 7 to 9, each of the driving shoes 100 includes a bottom portion 101, a first side wall 102 and a second side wall 103, a first sliding portion 104, a second sliding portion 105, an outer side engaging wall 106, a first sliding shaft 107, and a second sliding shaft 108.

The bottom portion 101 is formed in a plate shape having a plate thickness direction aligned with the second reference direction. The first side wall 102 and the second side wall 103 extend upward from the bottom portion 101. The first side wall 102 is located on the inner side in the width direction of the second side wall 103. In the width direction, the first side wall 102 is thinner than the second side wall 103, and in the first reference direction, the first side wall 102 is longer than the second side wall 103. The first sliding portion 104 extends inward in the width direction from an upper edge of the first side wall 102. The second sliding portion 105 extends outward in the width direction from an upper edge of the second side wall 103.

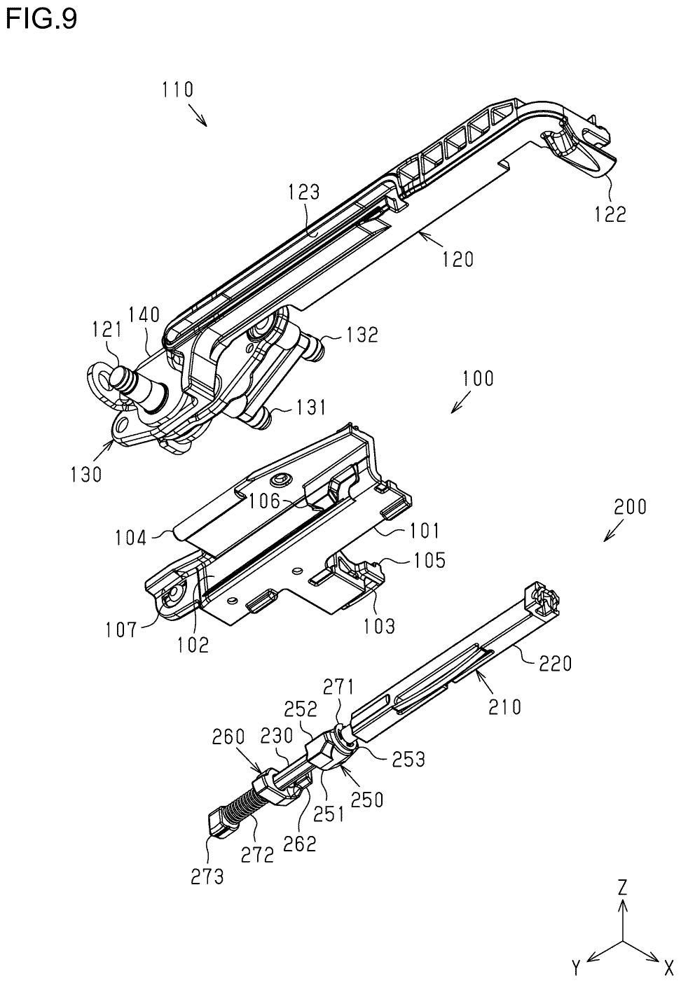

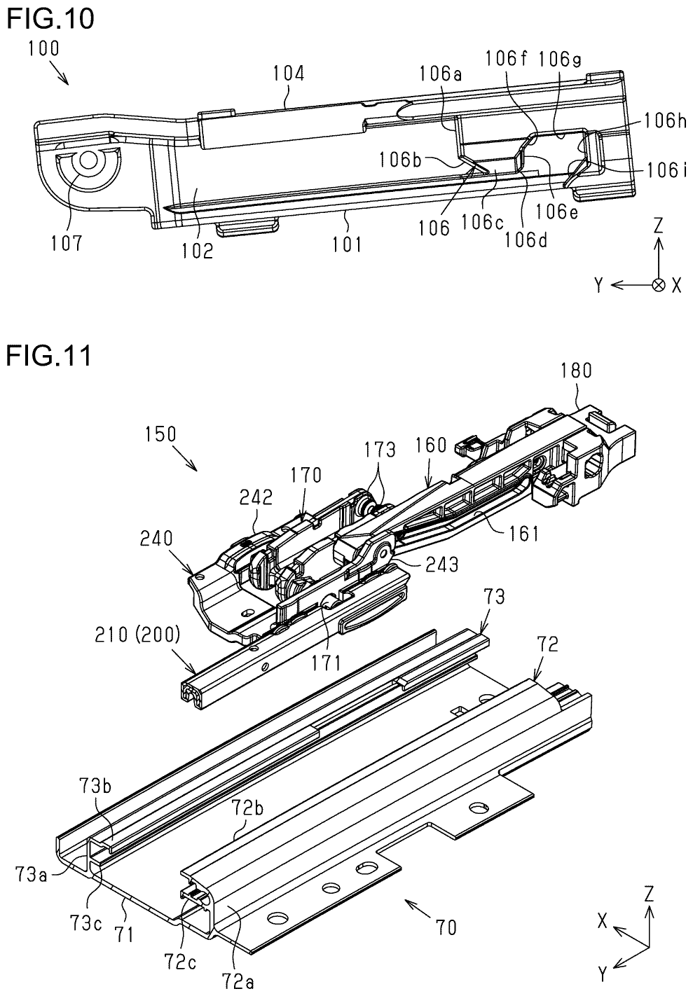

As illustrated in FIGS. 9 and 10, the outer side engaging wall 106 projects inward in the width direction from a rear end portion of the first side wall 102. As illustrated in FIG. 10, the outer side engaging wall 106 includes a contact surface 106a, a retracting surface 106b, a first outer side restricting surface 106c, an outer side auxiliary sliding surface 106d, a first pressing surface 106e, a second outer side restricting surface 106f, a third outer side restricting surface 106g, a second pressing surface 106h, and an outer side sliding surface 106i.

The contact surface 106a is a front end surface of the outer side engaging wall 106. The contact surface 106a extends in the second reference direction. The contact surface 106a preferably crosses the first reference direction at an angle close to the right angle. The retracting surface 106b crosses both the first reference direction and the second reference direction. Specifically, the retracting surface 106b is inclined downward toward the rear. A front edge of the retracting surface 106b is connected to a lower edge of the contact surface 106a. The first outer side restricting surface 106c extends in the first reference direction. A front edge of the first outer side restricting surface 106c is connected to a rear edge of the retracting surface 106b.

The outer side auxiliary sliding surface 106d crosses both the first reference direction and the second reference direction. Specifically, the outer side auxiliary sliding surface 106d is inclined upward toward the rear. A front edge of the outer side auxiliary sliding surface 106d is connected to a rear edge of the first outer side restricting surface 106c. The first pressing surface 106e extends in the second reference direction. The first pressing surface 106e preferably crosses the first reference direction at an angle close to the right angle. A lower edge of the first pressing surface 106e is connected to a rear edge of the outer side auxiliary sliding surface 106d. The second outer side restricting surface 106f crosses both the first reference direction and the second reference direction. Specifically, the second outer side restricting surface 106f is inclined upward toward the rear. A front edge of the second outer side restricting surface 106f is connected to an upper edge of the first pressing surface 106e.

The third outer side restricting surface 106g extends in the first reference direction. The third outer side restricting surface 106g preferably crosses the second reference direction at an angle close to the right angle. A front edge of the third outer side restricting surface 106g is connected to a rear edge of the second outer side restricting surface 106f. The second pressing surface 106h extends in the second reference direction. The second pressing surface 106h preferably crosses the first reference direction at an angle close to the right angle. An upper edge of the second pressing surface 106h is connected to a rear edge of the third outer side restricting surface 106g. The outer side sliding surface 106i crosses both the first reference direction and the second reference direction. Specifically, the outer side sliding surface 106i is inclined downward toward the front. A rear edge of the outer side sliding surface 106i is connected to a lower edge of the second pressing surface 106h. A front edge of the outer side sliding surface 106i is located below the first outer side restricting surface 106c.

With regard to the outer side engaging wall 106, the first outer side restricting surface 106c corresponds to a “first rear restricting surface”, the outer side auxiliary sliding surface 106d corresponds to a “first auxiliary sliding surface”, and the outer side sliding surface 106i corresponds to a “sliding surface” and a “second sliding surface”.

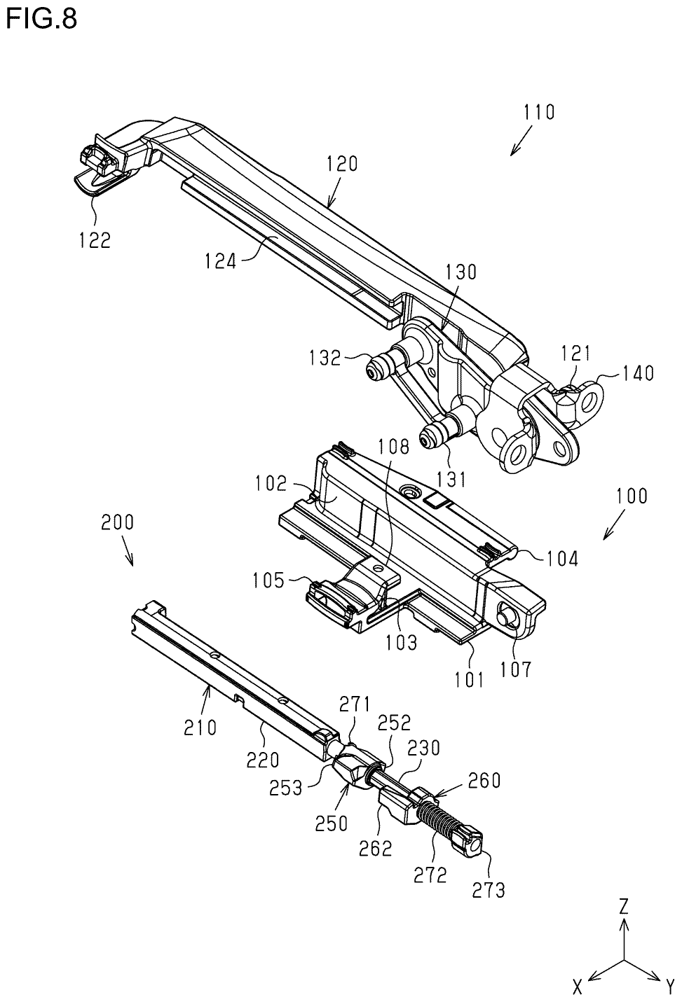

As illustrated in FIG. 8, the first sliding shaft 107 projects outward in the width direction from the first side wall 102. A cross-sectional shape of the first sliding shaft 107 orthogonal to a projecting direction of the first sliding shaft 107 is formed in a circle. The second sliding shaft 108 projects inward in the width direction from the second side wall 103. The second sliding shaft 108 is located on the rear side of the first sliding shaft 107. A cross-sectional shape of the second sliding shaft 108 orthogonal to a projecting direction of the second sliding shaft 108 is formed in a rectangular shape.

As illustrated in FIGS. 3 and 4, each of the driving shoes 100 is housed in one of the guide rails 70. On this occasion, the bottom portion 101 of the driving shoe 100 is located above the bottom wall 71 of the guide rail 70. The first sliding portion 104 of the driving shoe 100 is housed between the second inner wall 72b and the third inner wall 72c of the guide rail 70 in the up-down direction. The second sliding portion 105 of the driving shoe 100 is housed between the second outer wall 73b and the third outer wall 73c of the guide rail 70 in the up-down direction. In addition, the driving shoe 100 is sandwiched by the first inner wall 72a and the first outer wall 73a of the guide rail 70 in the width direction. In this manner, the driving shoe 100 is restricted from moving in a direction orthogonal to the long-side direction of the guide rail 70 by the guide rail 70. On the other hand, the driving shoe 100 is movable in the long-side direction of the guide rail 70 with respect to the guide rail 70. In addition, to the first sliding portion 104 of the driving shoe 100, one of the cables 52 of the actuator 50 is connected.

### <Front Support Portion 110>

As illustrated in FIGS. 7 to 9, each of the front support portions 110 includes a first front link 120, a second front link 130, and a bracket holding portion 140.

The first front link 120 is formed in a long plate shape. The first front link 120 includes a first guide shaft 121 and a swing shaft portion 122 that have axial directions aligned with the width direction and a first sliding groove 123 and a second sliding groove 124 that have depth directions aligned with the width direction. The first guide shaft 121 is located at a front end portion of the first front link 120. The swing shaft portion 122 is located at a rear end portion of the first front link 120. The first sliding groove 123 is formed on the inner side in the width direction of the first front link 120. The second sliding groove 124 is formed on the outer side in the width direction of the first front link 120. The first sliding groove 123 and the second sliding groove 124 extend along the long-side direction of the first front link 120. A rear end of the first sliding groove 123 and a rear end of the second sliding groove 124 open downward.

The second front link 130 is formed in a plate shape. The second front link 130 includes a second guide shaft 131 and a third guide shaft 132 that have axial directions aligned with the width direction. When viewed from a side in the width direction, the second guide shaft 131 is located at a central portion of the second front link 130, and the third guide shaft 132 is located at a rear end portion of the second front link 130. A front end portion of the second front link 130 is joined to the first front link 120 via the first guide shaft 121. The first front link 120 and the second front link 130 are relatively rotatable with respect to each other about an axis of the first guide shaft 121.

The bracket holding portion 140 is a part to which one of the front brackets 42 is fixed. The bracket holding portion 140 is joined to the first front link 120 and the second front link 130 via the first guide shaft 121. The bracket holding portion 140 is relatively rotatable with respect to the first front link 120 and the second front link 130 about the axis of the first guide shaft 121.

As illustrated in FIGS. 3 and 4, the front support portion 110 is housed in the guide unit 60. On this occasion, the first guide shaft 121 of the first front link 120 is inserted into the guide groove 84 of the inner side front guide 80. On the other hand, the second guide shaft 131 and the third guide shaft 132 of the second front link 130 are inserted into the guide groove 94 of the outer side front guide 90. In addition, the first front link 120 is located between the first sliding portion 104 and the second sliding portion 105 of the driving shoe 100 in the width direction. Further, the first sliding shaft 107 of the driving shoe 100 is inserted into the first sliding groove 123 of the first front link 120, and the second sliding shaft 108 of the driving shoe 100 is inserted into the second sliding groove 124 of the first front link 120. In addition, the swing shaft portion 122 of the first front link 120 is located between the bottom wall 71 and the second outer wall 73b of the guide rail 70 in the up-down direction. In addition, to the bracket holding portion 140, one of the front brackets 42 of the movable panel 40 is fixed. In this respect, the front support portions 110 support a front end portion of the movable panel 40.

### <Rear Support Portion 150>

As illustrated in FIGS. 11 to 13, each of the rear support portions 150 includes a first rear link 160, a second rear link 170, and a rear link support portion 180.

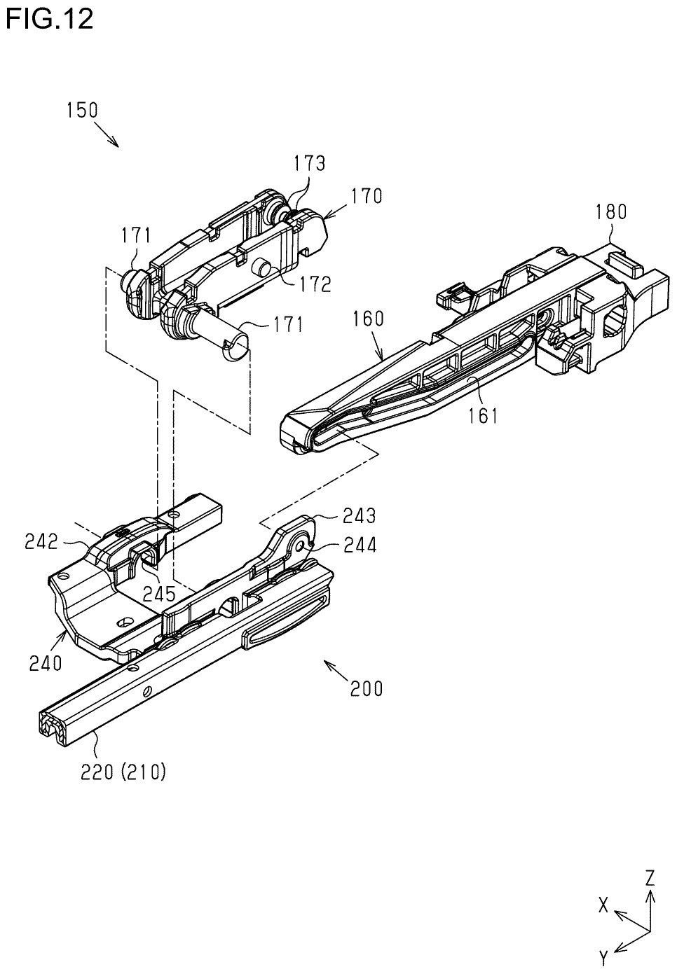

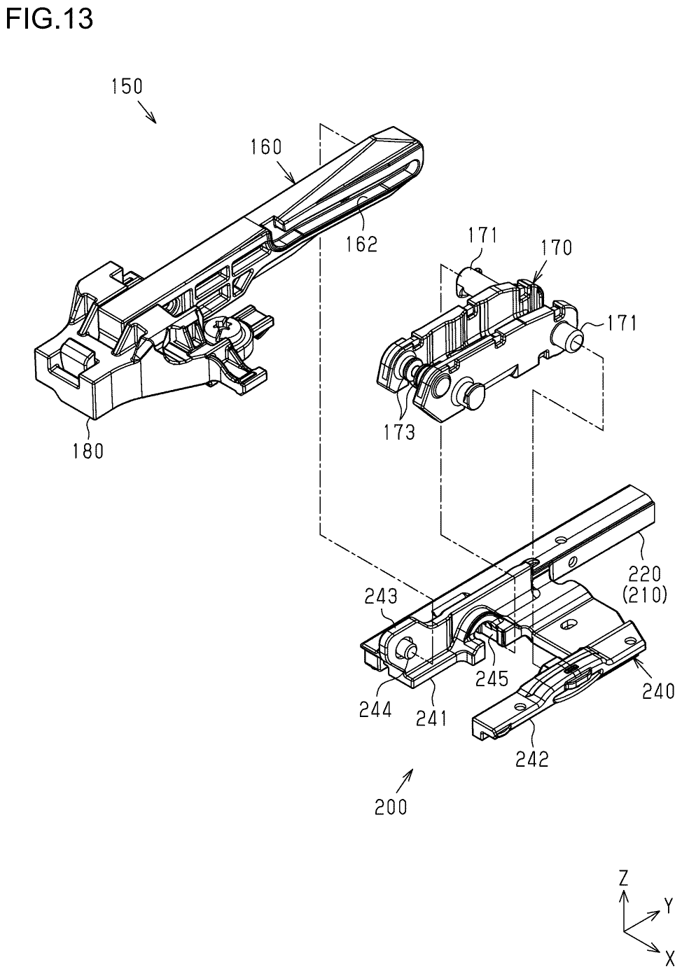

As illustrated in FIGS. 12 and 13, the first rear link 160 is formed in a rod shape. The first rear link 160 includes a third sliding groove 161 and a fourth sliding groove 162 that have depth directions aligned with the width direction. The third sliding groove 161 is formed on the inner side in the width direction of the first rear link 160. The fourth sliding groove 162 is formed on the outer side in the width direction of the first rear link 160. The third sliding groove 161 and the fourth sliding groove 162 extend along the long-side direction of the first rear link 160.

As illustrated in FIGS. 12 and 13, the second rear link 170 is formed in a rod shape. A cross-sectional shape of the second rear link 170 orthogonal to the long-side direction of the second rear link 170 is formed in the U-shape. The second rear link 170 includes two connecting shafts 171, a fourth sliding shaft 172, and two fourth guide shafts 173 that have axial directions aligned with the width direction. The two connecting shafts 171 are located at a front end portion of the second rear link 170. The fourth sliding shaft 172 is located at a central portion in the long-side direction of the second rear link 170. The two fourth guide shafts 173 are located at a rear end portion of the second rear link 170.

As illustrated in FIGS. 12 and 13, a base end portion of the first rear link 160 is supported by the rear link support portion 180 in a rotatable manner. In this manner, the first rear link 160 is rotatable about an axis extending in the width direction. The fourth sliding shaft 172 of the second rear link 170 is inserted into the fourth sliding groove 162 of the first rear link 160.

As illustrated in FIG. 11, each of the rear support portions 150 is housed in one of the guide rails 70. Specifically, the first rear link 160 and the second rear link 170 are located between the inner wall 72 and the outer wall 73 of the guide rail 70. In addition, the rear link support portion 180 is fixed to a rear end portion of the guide rail 70. In addition, the two fourth guide shafts 173 of the second rear link 170 slidably support one of the rear brackets 43 of the movable panel 40. In this respect, the rear support portions 150 support the movable panel 40 on the rear side of the front support portions 110.

### <Power Transmission Member 200>

As illustrated in FIGS. 7 to 9, 12, and 13, each of the power transmission members 200 includes a check rod 210, a check 250, a rotation restricting portion 260, a retaining ring 271, a biasing member 272, and a cap 273.

The check rod 210 includes a rod body 220, an extension shaft 230, and a rear shoe 240.

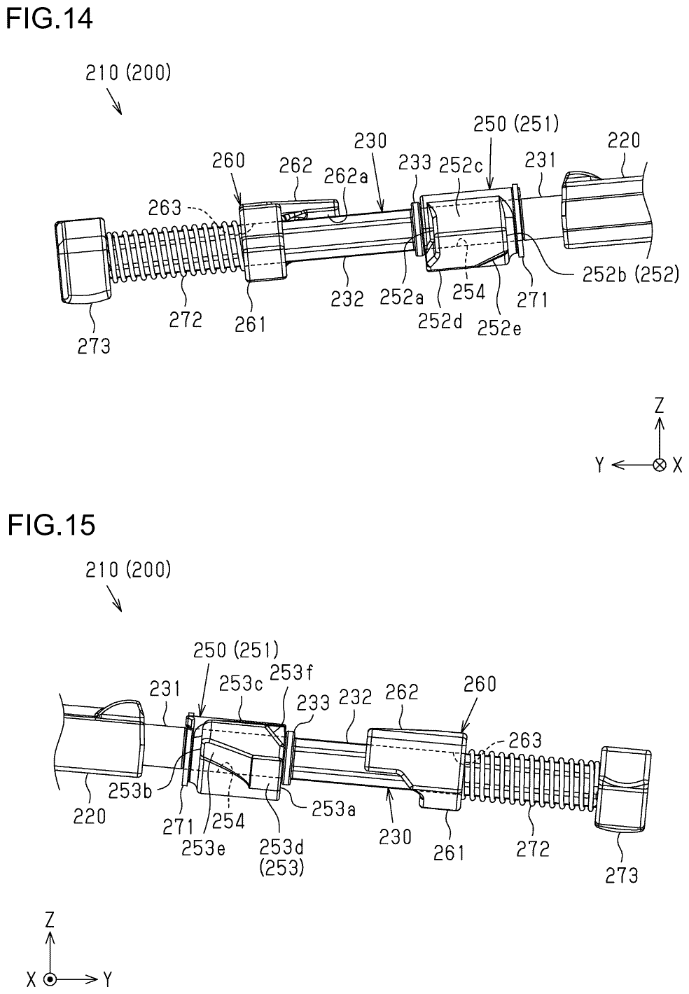

As illustrated in FIGS. 7 to 9, the rod body 220 is formed in a rod shape having the long-side direction aligned with the first reference direction. The rod body 220 curves, as with the guide rail 70. As illustrated in FIGS. 14 and 15, the extension shaft 230 extends along the first reference direction from a tip of the rod body 220. The extension shaft 230 includes a first shaft portion 231 that is formed in a columnar shape, a second shaft portion 232 that is formed in a polygonal columnar shape, and a flange 233 that demarcates the first shaft portion 231 and the second shaft portion 232 from each other. The first shaft portion 231 extends rearward from the flange 233, and the second shaft portion 232 extends forward from the flange 233. In the present embodiment, a cross-sectional shape of the second shaft portion 232 is formed in a hexagonal shape. The flange 233 is formed in a circular plate shape. Outer diameter of the first shaft portion 231 and outer diameter of the second shaft portion 232 are smaller than outer diameter of the flange 233.

As illustrated in FIGS. 12 and 13, the rear shoe 240 is connected to a rear end portion of the rod body 220. The rear shoe 240 includes a first sliding portion 241 and a second sliding portion 242 that are located with a gap interposed therebetween in the width direction, a retaining wall 243 that extends upward from the first sliding portion 241, and a third sliding shaft 244 that extends in the width direction from the retaining wall 243. The first sliding portion 241 is located on the inner side in the width direction of the second sliding portion 242. The first sliding portion 241 includes an engaging recessed portion 245 that is recessed upward from a bottom surface of the first sliding portion 241. Likewise, the second sliding portion 242 includes an engaging recessed portion 245 that is recessed upward from a bottom surface of the second sliding portion 242.

As illustrated in FIGS. 14 and 15, the check 250 is formed in a columnar shape having an axial direction aligned with the first reference direction. The check 250 includes a base portion 251 that is formed in a cylindrical shape and an inner side projecting portion 252 and an outer side projecting portion 253 that project from the base portion 251 in directions orthogonal to an axial direction of the base portion 251. The base portion 251 includes a support hole 254 that penetrates the base portion 251 in the axial direction. A cross-sectional shape of the support hole 254 is formed in a circular shape.

As illustrated in FIG. 14, the inner side projecting portion 252 tapers off with respect to a projecting direction of the inner side projecting portion 252 from the base portion 251. The inner side projecting portion 252 includes an inner side front surface 252a, an inner side rear surface 252b, an inner side upper surface 252c, an inner side lower surface 252d, and an inner side cam surface 252e.

The inner side front surface 252a is a front end surface of the inner side projecting portion 252 and is a surface that crosses the first reference direction. The inner side front surface 252a preferably crosses the first reference direction at an angle close to the right angle. The inner side front surface 252a is located slightly on the rear side of a front end surface of the base portion 251. The inner side rear surface 252b is a rear end surface of the inner side projecting portion 252 and is a surface that crosses the first reference direction. The inner side rear surface 252b preferably crosses the first reference direction at an angle close to the right angle. The inner side rear surface 252b is located slightly on the front side of a rear end surface of the base portion 251.

The inner side upper surface 252c is an upper surface of the inner side projecting portion 252 and is a surface that extends along the first reference direction. A front edge of the inner side upper surface 252c is connected to an upper edge of the inner side front surface 252a, and a rear edge of the inner side upper surface 252c is connected to an upper edge of the inner side rear surface 252b. The inner side lower surface 252d is a lower surface of the inner side projecting portion 252 and is a surface that extends along the first reference direction. A front edge of the inner side lower surface 252d is connected to a lower edge of the inner side front surface 252a. The inner side cam surface 252e crosses both the first reference direction and the second reference direction. In other words, the inner side cam surface 252e is inclined upward toward the rear. A front edge of the inner side cam surface 252e is connected to a rear edge of the inner side lower surface 252d, and a rear edge of the inner side cam surface 252e is connected to a lower edge of the inner side rear surface 252b.

As illustrated in FIG. 15, the outer side projecting portion 253 tapers off with respect to a projecting direction of the outer side projecting portion 253 from the base portion 251. The outer side projecting portion 253 includes an outer side front surface 253a, an outer side rear surface 253b, an outer side upper surface 253c, an outer side lower surface 253d, a first outer side cam surface 253e, and a second outer side cam surface 253f.

The outer side front surface 253a is a front end surface of the outer side projecting portion 253 and is a surface that crosses the first reference direction. The outer side front surface 253a preferably crosses the first reference direction at an angle close to the right angle. The outer side rear surface 253b is a rear end surface of the outer side projecting portion 253 and is a surface that crosses the first reference direction. The outer side rear surface 253b preferably crosses the first reference direction at an angle close to the right angle. The outer side upper surface 253c is an upper surface of the outer side projecting portion 253 and is a surface that extends along the first reference direction. A rear edge of the outer side upper surface 253c is connected to an upper edge of the outer side rear surface 253b. The outer side lower surface 253d is a lower surface of the outer side projecting portion 253 and is a surface that extends along the first reference direction. A front edge of the outer side lower surface 253d is connected to a lower edge of the outer side front surface 253a.

The first outer side cam surface 253e crosses both the first reference direction and the second reference direction. In other words, the first outer side cam surface 253e is inclined upward toward the rear. A front edge of the first outer side cam surface 253e is connected to a rear edge of the outer side lower surface 253d, and a rear edge of the first outer side cam surface 253e is connected to a lower edge of the outer side rear surface 253b. The second outer side cam surface 253f crosses both the first reference direction and the second reference direction. In other words, the second outer side cam surface 253f is inclined upward toward the rear. A front edge of the second outer side cam surface 253f is connected to an upper edge of the outer side front surface 253a, and a rear edge of the second outer side cam surface 253f is connected to a front edge of the outer side upper surface 253c.

Into the support hole 254 of the check 250, the first shaft portion 231 of the extension shaft 230 is inserted. In this manner, the check 250 is rotatable with respect to the extension shaft 230. On the other hand, the check 250 is sandwiched by the flange 233 and the retaining ring 271 in the axial direction of the extension shaft 230. Thus, the check 250 is immovable in the axial direction of the extension shaft 230.

As illustrated in FIGS. 14 and 15, the rotation restricting portion 260 includes a base portion 261 that is formed in a cylindrical shape and a holding portion 262 that extends rearward from the base portion 261. The base portion 261 includes a sliding hole 263 that penetrates the base portion 261 in the axial direction. A cross-sectional shape of the sliding hole 263 corresponds to the cross-sectional shape of the second shaft portion 232 of the extension shaft 230. In other words, the cross-sectional shape of the sliding hole 263 is formed in a hexagonal shape. The holding portion 262 is formed in a plate shape. The holding portion 262 includes a holding surface 262a that faces an axis of the sliding hole 263. The holding surface 262a is formed in a shape matching the outer side upper surface 253c of the check 250. Into the sliding hole 263 of the rotation restricting portion 260, the second shaft portion 232 of the extension shaft 230 is inserted. In this manner, the rotation restricting portion 260 is non-rotatable with respect to the extension shaft 230. On the other hand, the rotation restricting portion 260 is movable in the axial direction of the extension shaft 230. Note that as long as the base portion 261 is non-rotatable with respect to the second shaft portion 232 of the extension shaft 230, the cross-sectional shape of the sliding hole 263 and the cross-sectional shape of the second shaft portion 232 can be appropriately changed. For example, both the cross-sectional shape of the sliding hole 263 and the cross-sectional shape of the second shaft portion 232 may be a circle. The rotation restricting portion 260 corresponds to a “first restricting portion”, and the holding surface 262a corresponds to a “first front restricting surface”.

The cap 273 is formed in a shape equivalent to the shape of the base portion 261 of the rotation restricting portion 260. The cap 273 is fixed to a front edge of the extension shaft 230. The biasing member 272 is a coil spring. Into the biasing member 272, the second shaft portion 232 of the extension shaft 230 is inserted. The biasing member 272 is compressed between the cap 273 and the rotation restricting portion 260. In this manner, the biasing member 272 biases the rotation restricting portion 260 toward the flange 233. In other words, restoring force of the biasing member 272 is constantly exerted on the rotation restricting portion 260.

As illustrated in FIGS. 4 and 11, each of the power transmission members 200 is housed in one of the guide rails 70. On this occasion, the power transmission member 200 except the rear shoe 240 is located between the bottom wall 71 and the second inner wall 72b of the guide rail 70 in the up-down direction. The rear shoe 240 of the power transmission member 200 is located between the inner wall 72 and the outer wall 73 in the width direction. In addition, in the up-down direction, the first sliding portion 241 of the rear shoe 240 is located between the bottom wall 71 and the inner wall 72 of the guide rail 70 and the second sliding portion 242 of the rear shoe 240 is located between the bottom wall 71 and the outer wall 73 of the guide rail 70. In this manner, the power transmission member 200 is restricted from moving in the width direction and the up-down direction with respect to the guide rail 70. On the other hand, the power transmission member 200 is movable in the front-rear direction along the guide rail 70.

As illustrated in FIG. 4, the check 250 of the power transmission member 200 is engaged with the outer side engaging wall 106 of the driving shoe 100. In this manner, the power transmission member 200 can transmit power from the outer side engaging wall 106 of the driving shoe 100 via the check 250. As illustrated in FIGS. 12 and 13, the rear shoe 240 of the power transmission member 200 is engaged with the first rear link 160 and the second rear link 170 of the rear support portion 150. Specifically, the third sliding shaft 244 of the rear shoe 240 is inserted into the third sliding groove 161 of the first rear link 160. Into each of the two engaging recessed portions 245 of the rear shoe 240, one of the two connecting shafts 171 of the second rear link 170 is inserted. In this manner, the rear shoe 240 of the power transmission member 200 can transmit power to the first rear link 160 and the second rear link 170 via the two connecting shafts 171 and the third sliding shaft 244. In other words, to the rear support portion 150, power is indirectly transmitted from the driving shoe 100 via the power transmission member 200. On the other hand, to the front support portion 110, power is directly transmitted from the driving shoe 100 without involving the power transmission member 200.

### Operation of Present Embodiment

Operation of the sunroof device 30 is described.

Operation of the sunroof device 30 at the time of an opening operation of the movable panel 40 is described.

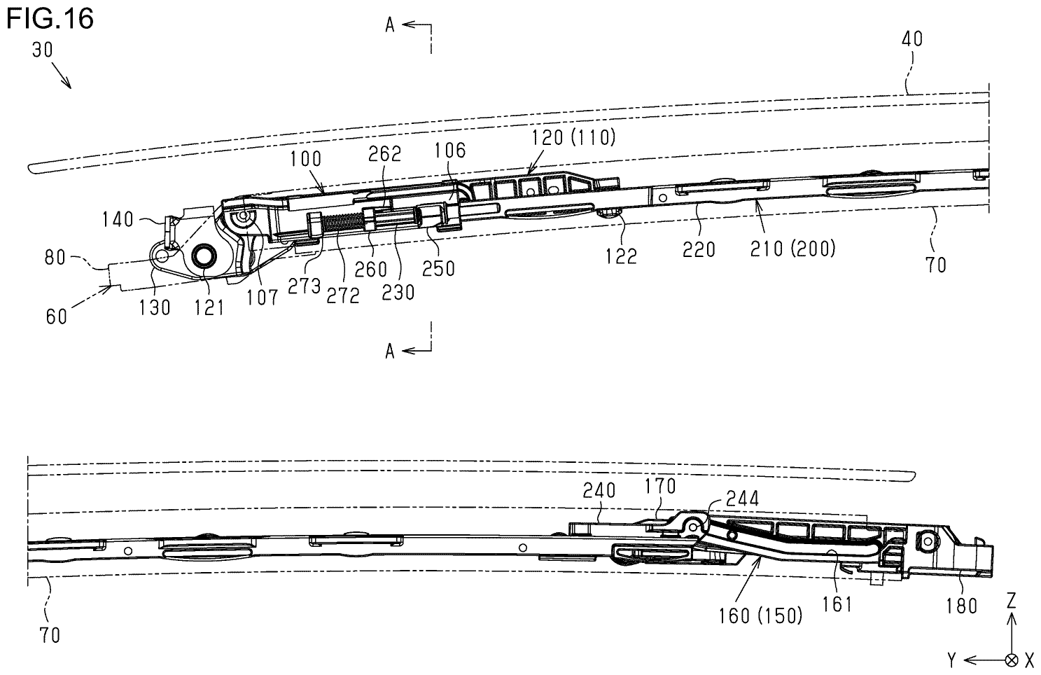

FIG. 16 illustrates the sunroof device 30 when the movable panel 40 is located at a full-close position. In a state illustrated in FIG. 16, each of the driving shoe 100 is located at a full-close corresponding position that is a forwardmost position within a moving range in the front-rear direction of the driving shoe 100. When the driving shoe 100 is located at the full-close corresponding position, the first front link 120 and the second front link 130 are not only located at forwardmost positions within moving ranges in the front-rear direction of the first front link 120 and the second front link 130 but also have fallen down in such a way as to extend along the guide rail 70. In addition, when the driving shoe 100 is located at the full-close corresponding position, the power transmission member 200 is located at a forwardmost position within a moving range in the front-rear direction of the power transmission member 200. Further, when the power transmission member 200 is located at the forwardmost position within the moving range in the front-rear direction of the power transmission member 200, the first rear link 160 and the second rear link 170 have fallen down in such a way as to extend along the guide rail 70.

Consequently, when the driving shoe 100 is located at the full-close corresponding position, the front end portion of the movable panel 40 that is supported by the first front link 120 has descended in respect that the first front link 120 has fallen down. In addition, the rear end portion of the movable panel 40 that is supported by the second rear link 170 has descended in respect that the second rear link 170 has fallen down. Further, in respect that the first front link 120 is located at the forwardmost position within the moving range of the first front link 120, the movable panel 40 is also located at a forwardmost position within a moving range the movable panel 40. As a result, the movable panel 40 is located at the full-close position.

When the movable panel 40 is caused to perform opening operation from the full-close position, the actuator 50 causes the driving shoes 100 to move rearward. When each of the driving shoes 100 moves rearward from the full-close corresponding position, in the front support portion 110, the first sliding shaft 107 and the second sliding shaft 108 of the driving shoe 100 move along the first sliding groove 123 and the second sliding groove 124 of the first front link 120, respectively. Thus, when the driving shoe 100 moves rearward from the full-close corresponding position, the first front link 120 substantially does not operate.

When the driving shoe 100 is located at the full-close corresponding position, the driving shoe 100 is engaged with the check 250 of the power transmission member 200. Thus, when the driving shoe 100 moves rearward from the full-close corresponding position, the power transmission member 200 moves rearward in conjunction with the driving shoe 100. When the power transmission member 200 moves rearward, in the rear support portion 150, the third sliding shaft 244 of the check rod 210 slides with the third sliding groove 161 of the first rear link 160. Then, the first rear link 160 rises with respect to the guide rail 70.

In addition, when the power transmission member 200 moves rearward, not only does the rear shoe 240 push the two connecting shafts 171 of the second rear link 170 rearward but also the fourth sliding shaft 172 of the second rear link 170 slides with the fourth sliding groove 162 of the first rear link 160. Then, the second rear link 170 rises with respect to the guide rail 70. Consequently, when the driving shoe 100 moves rearward from the full-close corresponding position, the first rear link 160 and the second rear link 170 rise. Thus, the rear end portion of the movable panel 40 supported by the two fourth guide shafts 173 of the second rear link 170 ascends.

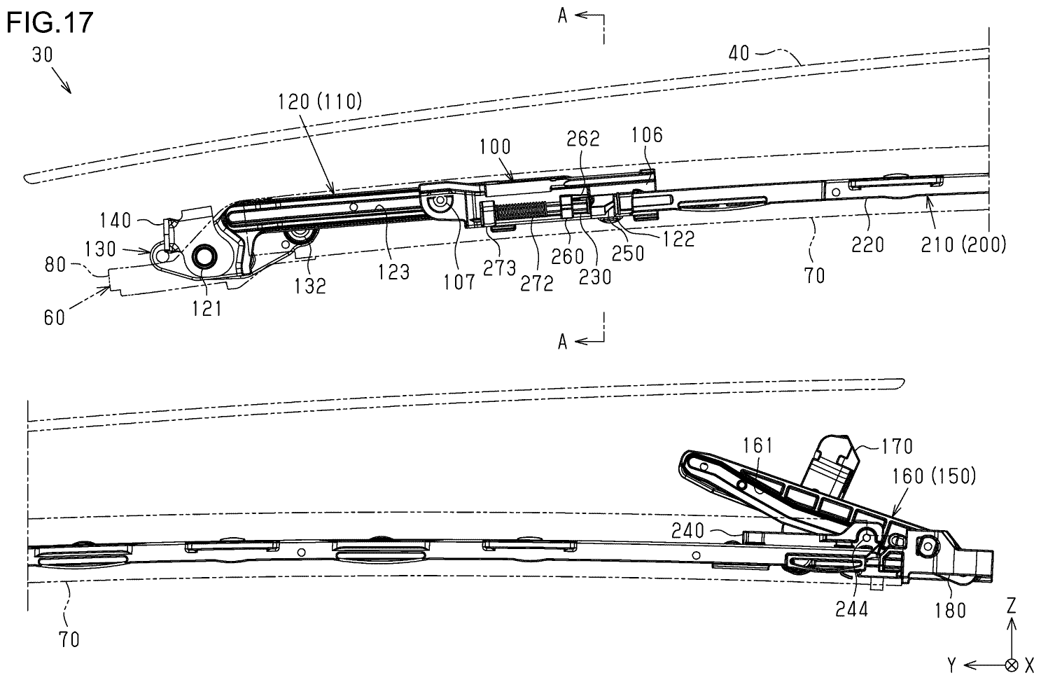

When the driving shoe 100 reaches a tilt-up corresponding position illustrated in FIG. 17, the first rear link 160 and the second rear link 170 are brought into a state of having risen most with respect to the guide rail 70. As a result, the movable panel 40 is arranged at a tilt-up position at which the rear end portion ascends higher than at the full-close position. When the driving shoe 100 reaches the tilt-up corresponding position, the engagement of the driving shoe 100 with the check 250 of the power transmission member 200 is released. Thus, when the driving shoe 100 moves rearward from the tilt-up corresponding position, power of the driving shoe 100 ceases to be transmitted to the rear support portion 150 via the power transmission member 200. Therefore, postures of the first rear link 160 and the second rear link 170 cease to change.

When the driving shoe 100 reaches the tilt-up corresponding position, in the front support portion 110, the first sliding shaft 107 of the driving shoe 100 reaches a vicinity of the rear end of the first sliding groove 123 of the first front link 120. Likewise, the second sliding shaft 108 of the driving shoe 100 reaches a vicinity of the rear end of the second sliding groove 124 of the first front link 120. Thus, when the driving shoe 100 moves rearward from the tilt-up corresponding position, the first front link 120 moves rearward by the driving shoe 100 pulling the first front link 120 rearward.

On this occasion, the first guide shaft 121 of the first front link 120 moves rearward along the guide groove 84 of the inner side front guide 80, and the second guide shaft 131 of the second front link 130 moves rearward along the guide groove 94 of the outer side front guide 90. Further, the third guide shaft 132 of the second front link 130 moves rearward along the guide rail 70. As a result, not only does the first front link 120 rotate about the swing shaft portion 122 but also the front end portion of the second front link 130 ascends with respect to the rear end portion of the second front link 130. As a result, the first front link 120 and the second front link 130 rise with respect to the guide rail 70. Thus, the front end portion of the movable panel 40 supported by the first front link 120 via the bracket holding portion 140 ascends.

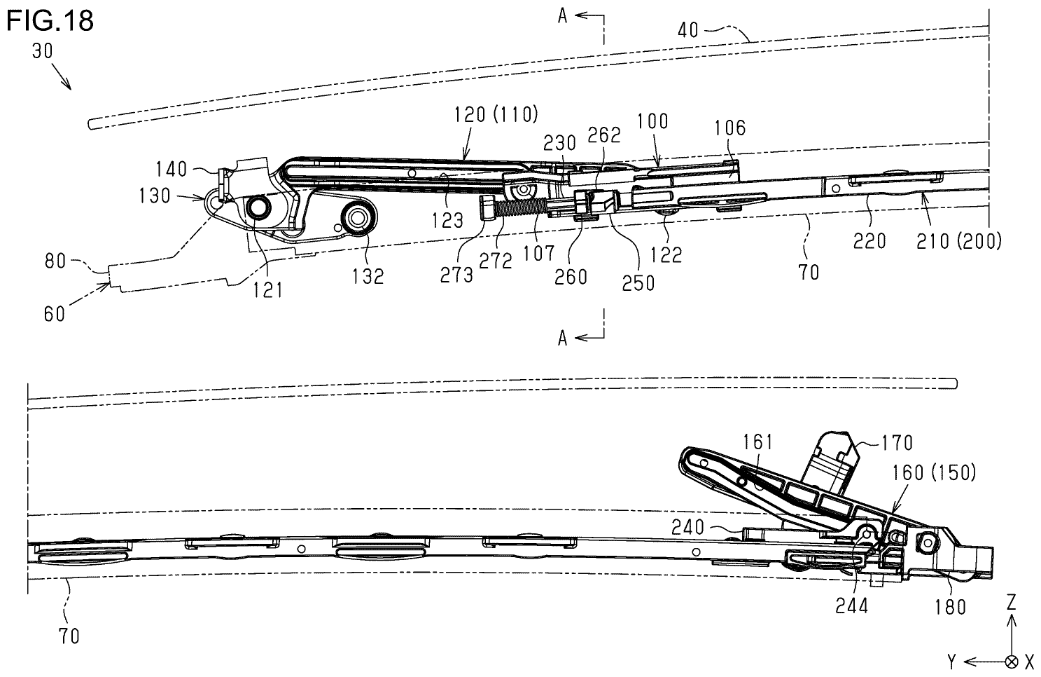

When the driving shoe 100 reaches a lift-up corresponding position illustrated in FIG. 18, the first front link 120 and the second front link 130 are brought into a state of having risen most with respect to the guide rail 70. As a result, the movable panel 40 is arranged at a lift-up position at which the front end portion ascends higher than at the tilt-up position. When the driving shoe 100 moves rearward from the lift-up position, the first guide shaft 121 and the swing shaft portion 122 of the first front link 120 move rearward along the guide rail 70. Likewise, the second guide shaft 131 and the third guide shaft 132 of the second front link 130 move rearward along the guide rail 70. In other words, the first front link 120 and the second front link 130 move rearward with postures thereof maintained. Thus, the movable panel 40 also moves rearward with a posture of the movable panel 40 maintained. On this occasion, each of the rear brackets 43 of the movable panel 40 slides with the two fourth guide shafts 173 of the second rear link 170. In other words, the movable panel 40 moves rearward with respect to the second rear links 170.

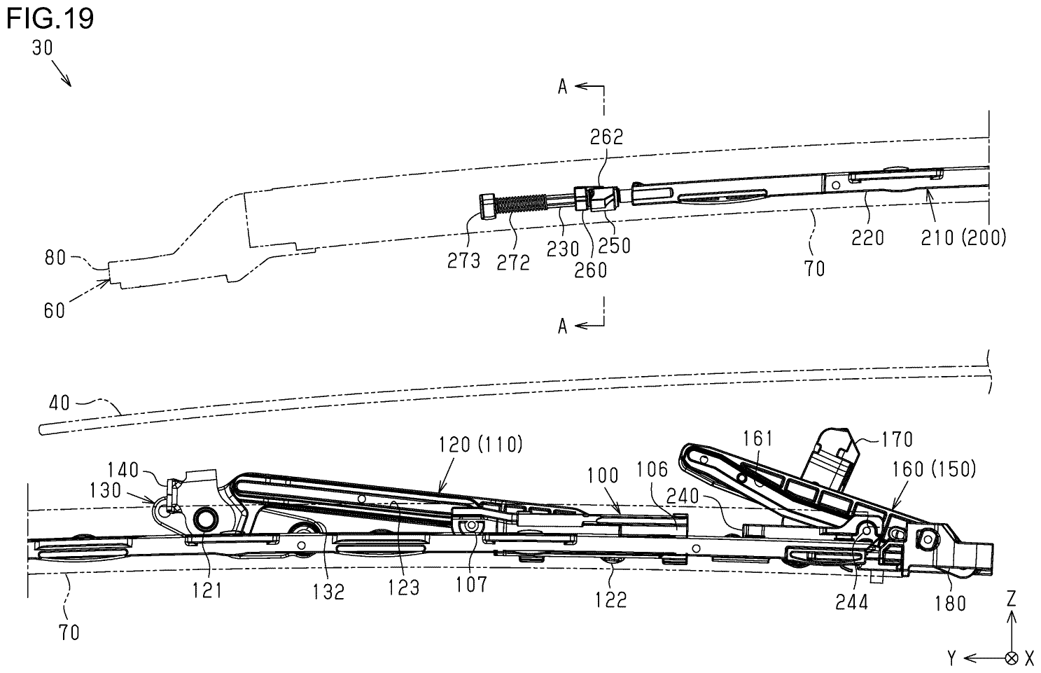

When the driving shoe 100 reaches a full-open corresponding position illustrated in FIG. 19, the first front link 120 is located at a rearwardmost position within the moving range of the first front link 120. As a result, the movable panel 40 is located at a full-open position that is a position located on the rear side of the lift-up position and at which the roof opening portion 25 is fully opened. In this manner, the movable panel 40 performs opening operation from the full-close position to the full-open position via the tilt-up position and the lift-up position.

Operation of each of the power transmission members 200 at the time of the opening operation of the movable panel 40 is described.

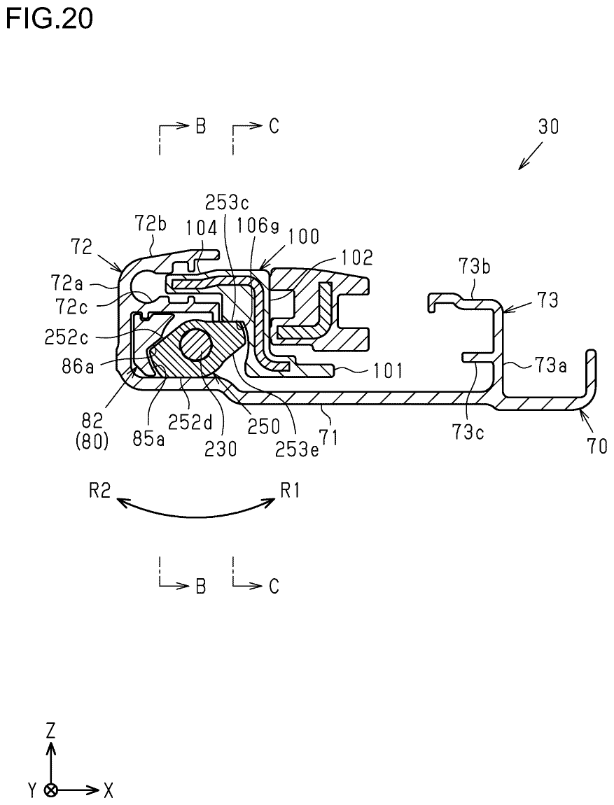

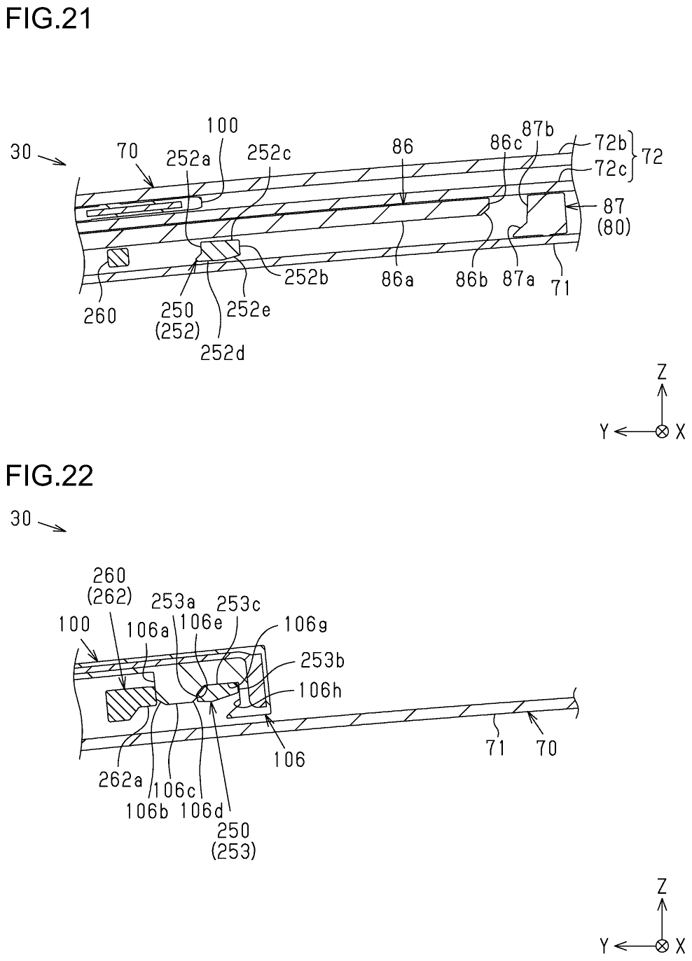

FIG. 20 is a cross-sectional view taken along the arrow line A-A in FIG. 16, in other words, a cross-sectional view crossing the check 250 when the driving shoe 100 is located at the full-close corresponding position. As illustrated in FIGS. 20 and 21, when the driving shoe 100 is located at the full-close corresponding position, the inner side upper surface 252c of the check 250 is in contact with the inner side restricting surface 86a of the inner side front guide 80. In addition, the inner side lower surface 252d of the check 250 is in contact with the bottom wall 71 of the guide rail 70. As illustrated in FIGS. 20 and 22, the outer side upper surface 253c of the check 250 is in contact with the third outer side restricting surface 106g of the driving shoe 100. In this respect, the driving shoe 100 is non-rotatable in both a first rotational direction R1 and a second rotational direction R2.

As illustrated in FIG. 22, in the front-rear direction, the outer side front surface 253a of the check 250 faces the first pressing surface 106e of the driving shoe 100. In other words, the driving shoe 100 is in a state of being able to transmit a rearward force to the check 250. In addition, the rotation restricting portion 260 is biased rearward by the biasing member 272. Thus, the holding portion 262 of the rotation restricting portion 260 is in contact with the contact surface 106a of the driving shoe 100. Meanwhile, the holding portion 262 of the rotation restricting portion 260 is not in contact with the check 250. In the following description, a position at which the holding surface 262a of the rotation restricting portion 260 does not come into contact with the outer side upper surface 253c of the check 250 within the moving range of the rotation restricting portion 260 is referred to as “rotation allowing position”.

Consequently, when each of the driving shoes 100 moves rearward from the full-close corresponding position, the first pressing surface 106e of the driving shoe 100 presses the outer side front surface 253a of the check 250 rearward. Thus, the check 250 moves rearward in conjunction with the driving shoe 100. In other words, the power transmission member 200 moves rearward in conjunction with the driving shoe 100. A position at which the check 250 is engaged with the driving shoe 100 in this way is referred to as “engagement position”. When the check 250 is located at the engagement position, the check 250 can move in the front-rear direction, based on power transmitted from the driving shoe 100.

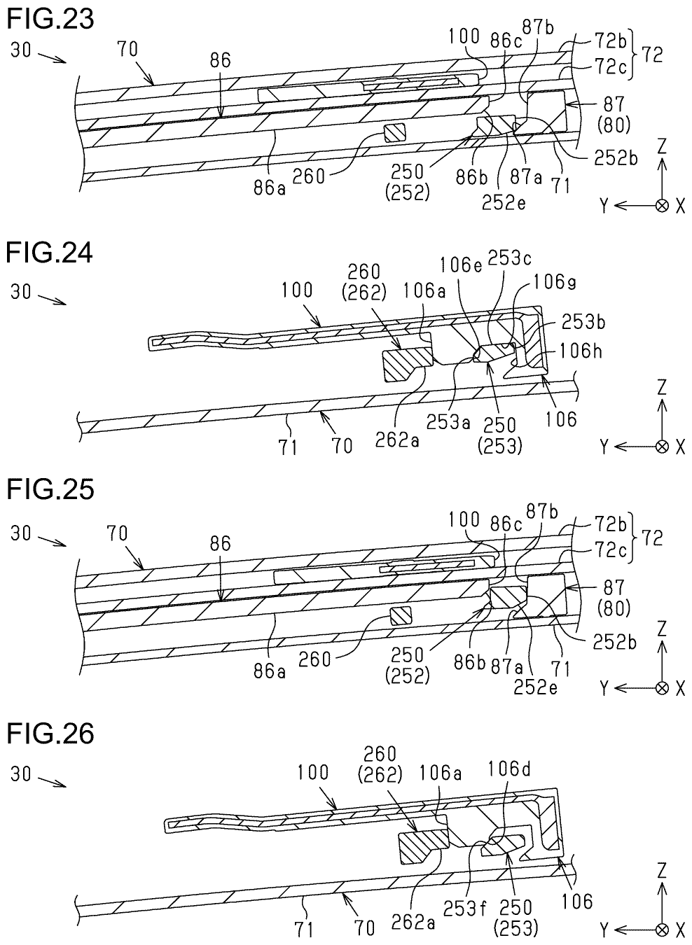

FIGS. 23 and 24 are cross-sectional views when the driving shoe 100 moves rearward from the full-close corresponding position. As illustrated in FIG. 23, when the driving shoe 100 moves rearward from the full-close corresponding position, the inner side projecting portion 252 of the check 250 comes into contact with the inner side sliding surface 87a of the inner side front guide 80. Note that inclination of the inner side cam surface 252e of the check 250 with respect to the second reference direction has a gentler gradient than inclination of the inner side sliding surface 87a of the inner side front guide 80 with respect to the second reference direction. Thus, a boundary between the inner side rear surface 252b and the inner side cam surface 252e of the check 250 comes into contact with the inner side sliding surface 87a of the inner side front guide 80. The inner side sliding surface 87a of the inner side front guide 80 is inclined upward toward the rear. Thus, when the driving shoe 100 moves rearward from a state illustrated in FIG. 23, the check 250 slides with the inner side sliding surface 87a of the inner side front guide 80.

FIGS. 25 and 26 are cross-sectional views when the check 250 and the inner side sliding surface 87a of the inner side front guide 80 have finished sliding with each other. As illustrated in FIG. 25, the check 250 sliding with the inner side sliding surface 87a of the inner side front guide 80 causes the inner side projecting portion 252 of the check 250 to be displaced upward. In contrast, as illustrated in FIG. 26, the outer side projecting portion 253 of the check 250 is displaced downward. In other words, the check 250 rotates in the second rotational direction R2.

As illustrated in FIG. 25, when the check 250 has finished sliding with the inner side sliding surface 87a of the inner side front guide 80, the inner side rear surface 252b of the check 250 comes into contact with the inner side clamping surface 87b of the inner side front guide 80. In addition, when the check 250 has finished sliding with the inner side sliding surface 87a of the inner side front guide 80, the outer side auxiliary sliding surface 106d of the driving shoe 100 comes into contact with the second outer side cam surface 253f of the check 250, as illustrated in FIG. 26. Note that both the outer side auxiliary sliding surface 106d of the driving shoe 100 and the second outer side cam surface 253f of the check 250 are inclined upward toward the rear. Thus, when the driving shoe 100 moves rearward from a state illustrated in FIG. 26, the outer side auxiliary sliding surface 106d of the driving shoe 100 and the second outer side cam surface 253f of the check 250 slide with each other. Not only is the outer side projecting portion 253 of the check 250 displaced downward but also the inner side projecting portion 252 of the check 250 is displaced upward. In other words, the check 250 further rotates in the second rotational direction R2.

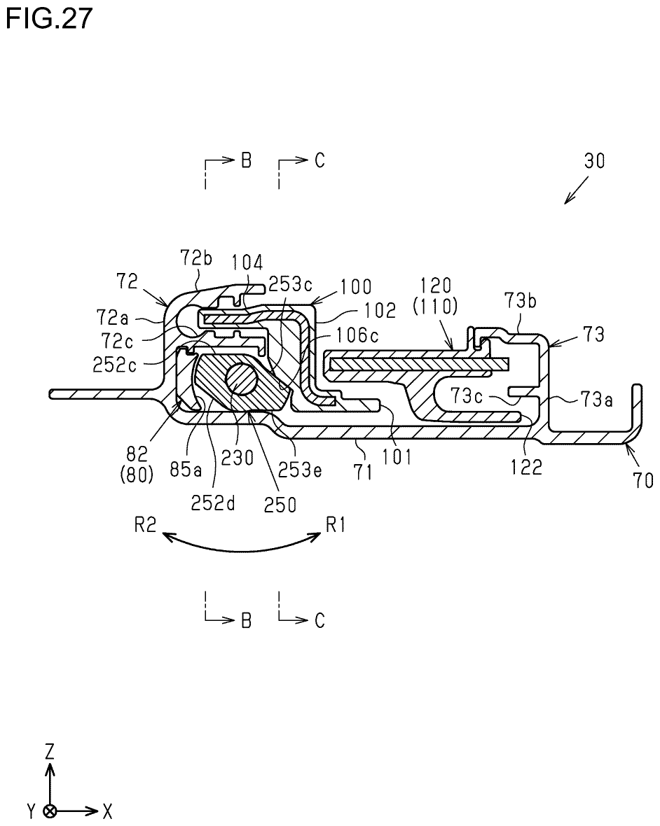

FIGS. 27 to 29 are cross-sectional views taken along the arrow line A-A in FIG. 17, in other words, cross-sectional views crossing the check 250 when the driving shoe 100 is located at the tilt-up corresponding position. FIGS. 27 to 29 are also cross-sectional views after the outer side auxiliary sliding surface 106d of the driving shoe 100 and the second outer side cam surface 253f of the check 250 have finished sliding with each other.

As illustrated in FIG. 29, when the driving shoe 100 is located at the tilt-up corresponding position, the check 250 ceases to exist in the rear of the outer side auxiliary sliding surface 106d of the driving shoe 100. Thus, even when the driving shoe 100 moves rearward, power ceased to be transmitted to the check 250. In the following description, a position of the check 250 illustrated in FIGS. 27 to 29 is referred to as “release position”. As illustrated in FIG. 27, the release position is a position at which a state in which the check 250 rotates most in the second rotational direction R2 is established.

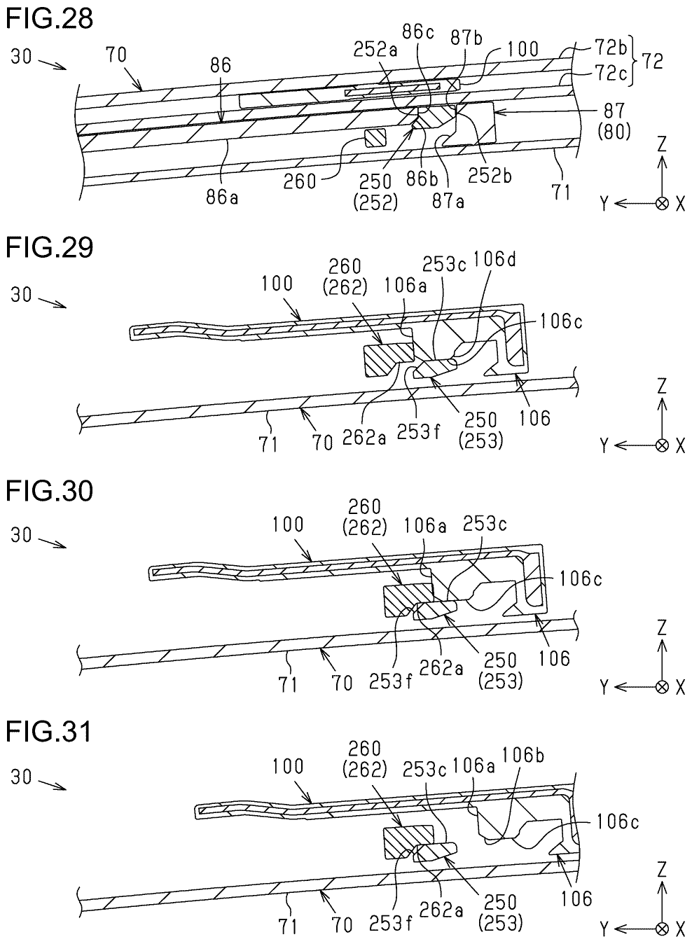

As illustrated in FIG. 28, when the driving shoe 100 is located at the tilt-up corresponding position, the inner side projecting portion 252 of the check 250 is located between the two inner side clamping surfaces 86c and 87b of the inner side front guide 80. In other words, the inner side front surface 252a of the check 250 faces the inner side clamping surface 86c of the inner side front guide 80, and the inner side rear surface 252b of the check 250 faces the inner side clamping surface 87b of the inner side front guide 80. Thus, the check 250 is prevented from moving in the front-rear direction with respect to the inner side front guide 80. In other words, the power transmission member 200 is prevented from moving in the front-rear direction. As a result, the postures of the first rear link 160 and the second rear link 170 are maintained.

As illustrated in FIGS. 27 and 29, the outer side projecting portion 253 of the check 250 is located below the driving shoe 100. In other words, the outer side upper surface 253c of the check 250 is in contact with the first outer side restricting surface 106c of the driving shoe 100. Thus, the check 250 is prevented from rotating in the first rotational direction R1 from the release position.

FIG. 30 is a cross-sectional view when the driving shoe 100 moves rearward from the tilt-up corresponding position. Since the check 250 is located at the release position, the driving shoe 100 moves rearward with respect to the check 250. On this occasion, the first outer side restricting surface 106c of the driving shoe 100 and the outer side upper surface 253c of the check 250 slide with each other. Meanwhile, the rotation restricting portion 260 that is biased rearward by the biasing member 272 moves rearward in conjunction with the driving shoe 100. Thus, in association with the rearward movement of the rotation restricting portion 260, the holding surface 262a of the rotation restricting portion 260 comes into contact with the outer side upper surface 253c of the check 250. Note that the front edge of the second outer side cam surface 253f of the check 250 is inclined downward toward the front. Thus, the check 250 is facilitated to slip beneath the holding portion 262 of the rotation restricting portion 260.

In this manner, a state in which only the driving shoe 100 is in contact with the outer side upper surface 253c of the check 250 as illustrated in FIG. 29 changes to a state in which both the driving shoe 100 and the rotation restricting portion 260 are in contact with the outer side upper surface 253c of the check 250 as illustrated in FIG. 30. In association with the rearward movement of the driving shoe 100, contact area between the driving shoe 100 and the check 250 decreases, and at the same time, contact area between the rotation restricting portion 260 and the check 250 increases. In the following description, a position at which the holding surface 262a of the rotation restricting portion 260 comes into contact with the outer side upper surface 253c of the check 250 within the moving range of the rotation restricting portion 260 is referred to as “rotation restricting position”.

When the rotation restricting portion 260 comes into contact with the flange 233 of the extension shaft 230, the rotation restricting portion 260 is prevented from moving rearward. Thus, after the rotation restricting portion 260 comes into contact with the flange 233, the rotation restricting portion 260 ceases to move rearward even when the driving shoe 100 moves rearward.

As illustrated in FIG. 31, when the driving shoe 100 moves rearward from the state illustrated in FIG. 30, the contact surface 106a of the driving shoe 100 moves to the rear side of the outer side projecting portion 253 of the check 250. In other words, the first outer side restricting surface 106c of the driving shoe 100 and the outer side upper surface 253c of the check 250 cease to slide with each other. As a result, the rotation restricting portion 260 and the check 250 are brought into a state in which only the holding surface 262a of the rotation restricting portion 260 is in contact with the outer side upper surface 253c of the check 250.

Operation of the sunroof device 30 at the time of a closing operation of the movable panel 40 is simply described.

When the movable panel 40 is caused to perform the closing operation from the full-open position as illustrated in FIG. 19, the actuator 50 drives the driving shoes 100 forward. When each of the driving shoes 100 moves forward from the full-open corresponding position, the driving shoe 100 moves forward in conjunction with the front support portions 110. On this occasion, the front support portion 110 moves forward while maintaining the posture of the front support portion 110 with respect to the guide unit 60. As a result, the movable panel 40 moves forward from the full-open position while maintaining the posture of the movable panel 40 with respect to the guide units 60.

When the driving shoe 100 reaches the lift-up corresponding position as illustrated in FIG. 18, the movable panel 40 is arranged at the lift-up position. When the driving shoe 100 moves forward from the lift-up corresponding position, the posture of the front support portion 110 changes. Specifically, the first front link 120 and the second front link 130 are displaced in such a manner as to fall down with respect to the guide unit 60. As a result, the front end portion of the movable panel 40 descends.

When the driving shoe 100 reaches the tilt-up corresponding position as illustrated in FIG. 17, the movable panel 40 is arranged at the tilt-up position. When the driving shoe 100 moves forward from the tilt-up corresponding position, the posture of the front support portion 110 does not change. On the other hand, when the driving shoe 100 moves forward from the tilt-up corresponding position, the driving shoe 100 and the check 250 of the power transmission member 200 are engaged with each other. Thus, the power transmission member 200 is brought into a state of being able to transmit power of the driving shoe 100 to the rear support portion 150. As a result, when the driving shoe 100 moves forward from the tilt-up corresponding position, the posture of the rear support portion 150 changes. Specifically, the first rear link 160 and the second rear link 170 are displaced in such a manner as to fall down with respect to the guide unit 60. As a result, the rear end portion of the movable panel 40 descends.

When the driving shoe 100 reaches the full-close corresponding position as illustrated in FIG. 16, the movable panel 40 is arranged at the full-close position. In this manner, the movable panel 40 performs the closing operation from the full-open position to the full-close position via the lift-up position and the tilt-up position.

Operation of each of the power transmission members 200 at the time of the closing operation of the movable panel 40 is described.

When each of the driving shoes 100 is located at the full-open corresponding position as illustrated in FIG. 19, the check 250 is located at the release position and the rotation restricting portion 260 is located at the rotation restricting position. Thus, the check 250 is non-rotatable from the release position to the engagement position.

When the driving shoe 100, after passing the lift-up corresponding position, moves toward the tilt-up corresponding position, an engagement relationship between the driving shoe 100 and the check 250 changes. Specifically, as illustrated in FIGS. 30 and 31, in association with the forward movement of the driving shoe 100, the first outer side restricting surface 106c of the driving shoe 100 comes into contact with the outer side upper surface 253c of the check 250. Note that since the retracting surface 106b of the driving shoe 100 is inclined downward toward the rear, the outer side upper surface 253c of the check 250 is facilitated to slip beneath the retracting surface 106b and the first outer side restricting surface 106c of the driving shoe 100.

In this manner, a state in which only the rotation restricting portion 260 is in contact with the outer side upper surface 253c of the check 250 as illustrated in FIG. 31 changes to a state in which both the driving shoe 100 and the rotation restricting portion 260 are in contact with the outer side upper surface 253c of the check 250 as illustrated in FIG. 30. When the driving shoe 100 further moves forward, the contact surface 106a of the driving shoe 100 comes into contact with the holding portion 262 of the rotation restricting portion 260. After the driving shoe 100 comes into contact with the rotation restricting portion 260, the rotation restricting portion 260 moves forward in conjunction with the driving shoe 100. When the rear end of the holding portion 262 of the rotation restricting portion 260 moves to the front side of the front edge of the outer side upper surface 253c of the check 250, the holding surface 262a of the rotation restricting portion 260 ceases to be in contact with the outer side upper surface 253c of the check 250. In other words, only the first outer side restricting surface 106c of the driving shoe 100 is brought into a state of being in contact with the outer side upper surface 253c of the check 250.

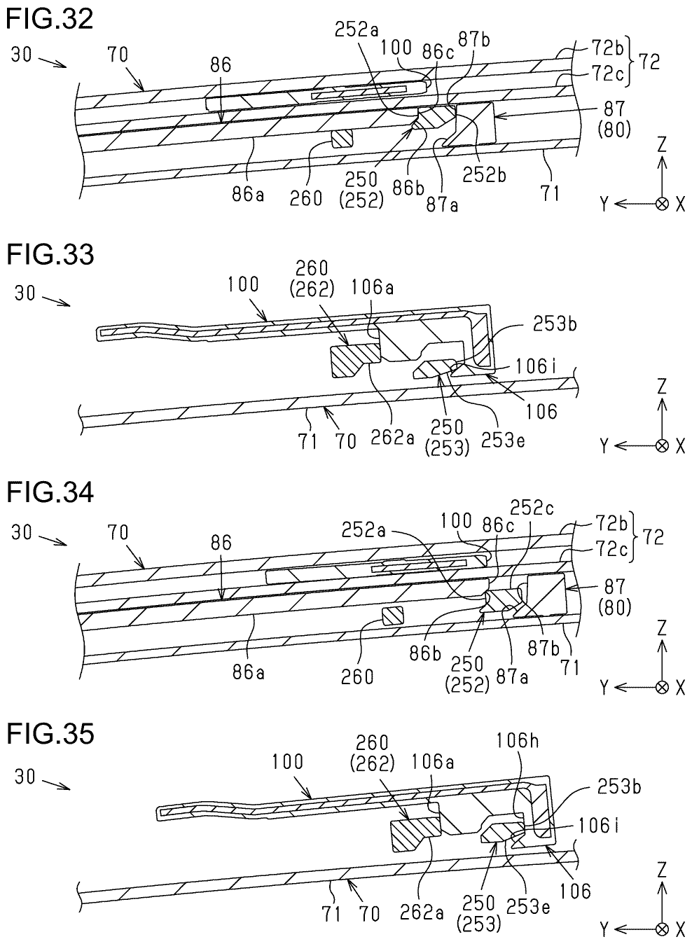

FIGS. 32 and 33 are cross-sectional views when the driving shoe 100 moves forward from the tilt-up corresponding position. As illustrated in FIG. 33, when the driving shoe 100 moves forward from the tilt-up corresponding position, the first outer side restricting surface 106c of the driving shoe 100 ceases to be in contact with the outer side upper surface 253c of the check 250. In other words, the check 250 becomes rotatable from the release position in the first rotational direction R1. Succeedingly, the outer side sliding surface 106i of the driving shoe 100 comes into contact with the outer side projecting portion 253 of the check 250. Note that inclination of the first outer side cam surface 253e of the check 250 with respect to the second reference direction has a gentler gradient than inclination of the outer side sliding surface 106i of the driving shoe 100 with respect to the second reference direction. Thus, with the outer side sliding surface 106i of the driving shoe 100 moving forward, a boundary between the outer side rear surface 253b and the first outer side cam surface 253e of the check 250 comes into contact. The outer side sliding surface 106i of the driving shoe 100 is inclined upward toward the rear. Thus, when the driving shoe 100 moves forward from the state illustrated in FIG. 33, the check 250 slides with the outer side sliding surface 106i of the driving shoe 100.

FIGS. 34 and 35 are cross-sectional views when the check 250 has finished sliding with the outer side sliding surface 106i of the driving shoe 100. As illustrated in FIG. 35, the check 250 sliding with the outer side sliding surface 106i of the driving shoe 100 causes the outer side projecting portion 253 of the check 250 is displaced upward. In contrast, as illustrated in FIG. 34, the inner side projecting portion 252 of the check 250 is displaced downward. In other words, the check 250 rotates in the first rotational direction R1.

As illustrated in FIG. 35, when the check 250 has finished sliding with the outer side sliding surface 106i of the driving shoe 100, a boundary between the inner side front surface 252a and the inner side upper surface 252c of the check 250 comes into contact with the inner side auxiliary sliding surface 86b of the inner side front guide 80, as illustrated in FIG. 34. Note that the inner side auxiliary sliding surface 86b of the inner side front guide 80 is inclined upward toward the rear. Thus, when the driving shoe 100 continues moving forward, the check 250 slides with the inner side auxiliary sliding surface 86b of the inner side front guide 80.

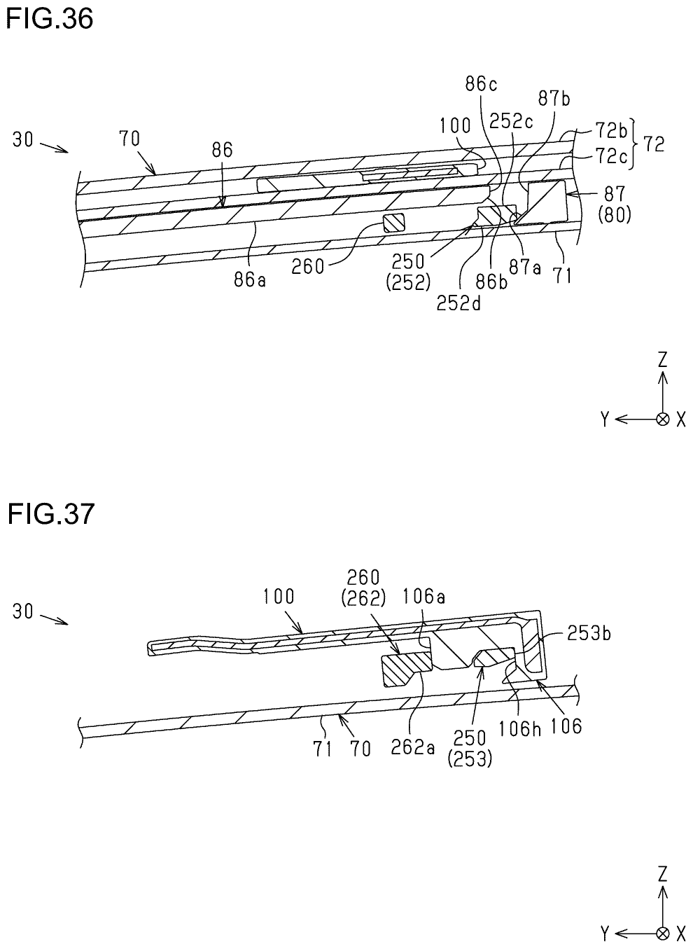

FIGS. 36 and 37 are cross-sectional views when the check 250 has finished sliding with the inner side auxiliary sliding surface 86b of the inner side front guide 80. The check 250 sliding with the inner side auxiliary sliding surface 86b of the inner side front guide 80 causes not only the inner side projecting portion 252 of the check 250 to be displaced downward but also the outer side projecting portion 253 of the check 250 to be displaced upward. In other words, the check 250 further rotates in the first rotational direction R1. In this manner, the check 250 rotates to the engagement position.

As illustrated in FIG. 37, when the check 250 is located at the engagement position, the outer side rear surface 253b of the check 250 is in contact with the second pressing surface 106h of the driving shoe 100. In other words, the driving shoe 100 is in a state of being able to transmit a forward force to the power transmission member 200 via the check 250. Thus, when the driving shoe 100 moves forward from a state illustrated in FIGS. 36 and 37, the second pressing surface 106h of the driving shoe 100 presses forward the outer side rear surface 253b of the check 250. Thus, the check 250 moves forward in conjunction with the driving shoe 100. In other words, the power transmission member 200 moves forward in conjunction with the driving shoe 100.

In addition, when the driving shoe 100 moves forward, the inner side restricting surface 86a of the inner side front guide 80 is located immediately above the inner side upper surface 252c of the check 250. Thus, the inner side projecting portion 252 of the check 250 is prevented from being displaced upward. In other words, the check 250 is prevented from rotating from the engagement position toward the release position.

### Advantageous Effects of Present Embodiment

(1) Each of the checks 250 rotates between the engagement position at which power can be transmitted from the corresponding driving shoe 100 to the corresponding rear support portion 150 and the release position at which power cannot be transmitted from the driving shoe 100 to the rear support portion 150. In other words, in respect that the check 250 does not move in the up-down direction between the engagement position and the release position, thickness in the up-down direction of the sunroof device 30 can be prevented from increasing. In addition, in respect that the check 250 does not move in the width direction between the engagement position and the release position, body size in the width direction of the sunroof device 30 can be prevented from increasing.

Further, when the driving shoe 100 move rearward toward the tilt-up corresponding position, the check 250 rotates toward the release position by sliding with the inner side sliding surface 87a of the corresponding guide unit 60. On the other hand, when the driving shoe 100 moves forward from the tilt-up corresponding position, the check 250 rotates toward the engagement position by sliding with the outer side sliding surface 106i of the driving shoe 100. Thus, the sunroof device 30 can cause each of the checks 250 to rotate to a necessary position depending on the movement direction of the corresponding driving shoe 100.

In addition, the first rotational direction R1 and the second rotational direction R2, which are directions in which the check 250 operates, are different directions from the first reference direction, which is a direction in which power is transmitted from the driving shoe 100. Thus, the sunroof device 30 can prevent each of the checks 250 from malfunctioning based on power transmitted from the corresponding driving shoe 100.

(2) Each of the power transmission members 200 includes the rotation restricting portion 260 that when the corresponding driving shoe 100 is located on the rear side of the tilt-up corresponding position, restricts the corresponding check 250 from rotating from the release position to the engagement position. Thus, when each of the driving shoes 100 is located on the rear side of the tilt-up corresponding position, the sunroof device 30 can prevent the position of the corresponding check 250 from changing from the release position. Therefore, the sunroof device 30 can cause the outer side sliding surface 106i of each of the driving shoes 100 to come into contact with the corresponding check 250 when the driving shoe 100 moves forward from the tilt-up corresponding position.

(3) Each of the guide units 60 includes the first inner side engaging wall 86 that when the corresponding driving shoe 100 is located on the front side of the tilt-up corresponding position, restricts the check 250 from rotating from the engagement position to the release position. Thus, when each of the driving shoes 100 is located on the front side of the tilt-up corresponding position, the sunroof device 30 can prevent the position of the corresponding check 250 from changing from the engagement position. Therefore, the sunroof device 30 can cause each of the checks 250 to come into contact with the inner side sliding surface 87a of the corresponding inner side front guide 80 when the driving shoe 100 moves rearward from the tilt-up corresponding position.

(4) Each of the checks 250 and the corresponding rotation restricting portion 260 are supported by the check rod 210. Thus, the sunroof device 30 can easily manage a positional relationship between each of the checks 250 and the corresponding rotation restricting portion 260. In addition, the rotation restricting portion 260 is displaced between the rotation allowing position and the rotation restricting position by moving in the axial direction of the check rod 210. In other words, a position in the up-down direction of the rotation restricting portion 260 substantially does not change when the rotation restricting portion 260 is displaced between the rotation allowing position and the rotation restricting position. Therefore, the thickness in the up-down direction of the sunroof device 30 can be prevented from increasing to secure a moving range of the rotation restricting portion 260.

(5) In the sunroof device 30, when each of the driving shoes 100 is located on the front side of the tilt-up corresponding position, the first outer side restricting surfaces 106c of the driving shoe 100 restrict rotation of the corresponding check 250. On the other hand, when the driving shoe 100 is located on the rear side of the tilt-up corresponding position, the holding surface 262a of the corresponding rotation restricting portion 260 restricts rotation of the check 250. When an object restricting the rotation of the check 250 changes from one of the driving shoe 100 and the rotation restricting portion 260 to the other, a state exists in which both the driving shoe 100 and the rotation restricting portion 260 restrict the rotation of the check 250. Therefore, when a state in which one of the driving shoe 100 and the rotation restricting portion 260 is in contact with the check 250 changes to a state in which the other is in contact with the check 250, the sunroof device 30 can prevent the posture of the check 250 from largely changing or an abnormal noise from being generated.

(6) Each of the power transmission members 200 include the biasing member 272 that biases the rotation restricting portion 260 from the rotation allowing position toward the rotation restricting position. In other words, the power transmission member 200 can move the rotation restricting portion 260 between the rotation allowing position and the rotation restricting position in an interlocking manner with the position of the corresponding driving shoe 100.

(7) In the sunroof device 30, when each of the driving shoes 100 is located on the rear side of the tilt-up corresponding position, the two inner side clamping surfaces 86c and 87b of the corresponding guide unit 60 clamp the corresponding check 250 in the front-rear direction. Thus, when the driving shoe 100 is located on the rear side of the tilt-up corresponding position, the corresponding power transmission member 200 is restricted from moving in the front-rear direction. Therefore, the sunroof device 30 can prevent each of the power transmission members 200 from moving due to a load exerted on the corresponding rear support portion 150 or each of the rear support portions 150 from moving due to a load exerted on the corresponding power transmission member 200.

(8) The two inner side clamping surfaces 86c and 87b of each of the guide units 60 cross the first reference direction at an angle close to the right angle. Thus, even when an external force in the front-rear direction is exerted on each of the power transmission members 200, the corresponding check 250 is unlikely to slide with the two inner side clamping surfaces 86c and 87b of the guide unit 60. In other words, the check 250 is unlikely to move in the up-down direction with respect to the two inner side clamping surfaces 86c and 87b of the guide unit 60. In respect of this point, the sunroof device 30 can more strictly restrict movement of each of the checks 250 located at the release position.

(9) Each of the checks 250 rotates from the engagement position to the release position by the corresponding driving shoe 100 moving rearward toward the tilt-up position. Specifically, the check 250 starts rotating from the engagement position by sliding with the inner side sliding surface 87a of the corresponding guide unit 60. Subsequently, the check 250 rotates to the release position by sliding with the outer side auxiliary sliding surface 106d of the driving shoe 100. In this way, the sunroof device 30 causes each of the check 250 to not only slide with the inner side sliding surface 87a of the corresponding guide unit 60 but also slide with the outer side auxiliary sliding surface 106d of the corresponding driving shoe 100. As a result, the sunroof device 30 can arrange each of the checks 250 between the two inner side clamping surfaces 86c and 87b of the corresponding guide unit 60 at the release position.

(10) The inner side front guide 80 of each of the guide units 60 includes the inner side sliding surface 87a, and each of the driving shoes 100 includes the outer side sliding surface 106i. Thus, when compared with a case where one of the guide unit 60 and the driving shoe 100 includes constituent elements equivalent to both the inner side sliding surface 87a and the outer side sliding surface 106i, a structure of the device can be prevented from being complex.

(11) When each of the driving shoes 100 moves rearward, the first pressing surface 106e of the driving shoe 100 presses the outer side front surface 253a of the corresponding check 250 rearward. In contrast, when the driving shoe 100 moves forward, the second pressing surface 106h of the driving shoe 100 presses the outer side rear surface 253b of the check 250 forward. Note that the first pressing surface 106e and the second pressing surface 106h of the driving shoe 100 and the outer side front surface 253a and the outer side rear surface 253b of the check 250 cross the first reference direction at an angle close to the right angle. Thus, when the driving shoe 100 presses the check 250 in the front-rear direction, torque is unlikely to be generated on the check 250. Therefore, when each of the driving shoes 100 presses the corresponding check 250 in the front-rear direction, the sunroof device 30 can prevent sliding resistance between the check 250 and the corresponding guide rail 70 from increasing.

(12) Each of the checks 250 is clamped in the front-rear direction by the two inner side clamping surfaces 86c and 87b of the corresponding inner side front guide 80 at the release position. Specifically, the inner side front surface 252a of the check 250 and the inner side clamping surface 86c of the inner side front guide 80 face each other, and the inner side rear surface 252b of the check 250 and the inner side clamping surface 87b of the inner side front guide 80 face each other. Thus, when a forward external force is exerted on the corresponding power transmission member 200, a rearward load is exerted on the inner side front surface 252a of the check 250 by contact with the inner side clamping surface 86c. In addition, when a rearward external force is exerted on the power transmission member 200, a forward load is exerted on the inner side rear surface 252b of the check 250 by contact with the inner side clamping surface 87b. As a result, there is a possibility that stress concentration occurs around the opening of the support hole 254 of the check 250. In this respect, in the check 250, the outer side front surface 253a is recessed rearward with respect to the front end surface of the base portion 251, and the outer side rear surface 253b is recessed forward with respect to the rear end surface of the base portion 251. Thus, the sunroof device 30 can mitigate stress concentration occurring around the opening of the support hole 254 of each of the checks 250.

### <Modifications>

The present embodiment can be embodied by being modified as follows. The present embodiment and the following modifications can be embodied by being combined with one another unless technically contradicting one another.
The inner side sliding surface 87a of the guide unit 60 and the outer side auxiliary sliding surface 106d of the driving shoe 100 are constituent elements to cause the check 250 to rotate from the engagement position to the release position by the driving shoe 100 sliding with the check 250 when moving rearward. Thus, one of the inner side sliding surface 87a of the guide unit 60 and the outer side auxiliary sliding surface 106d of the driving shoe 100 can be omitted. When, for example, the inner side sliding surface 87a of the guide unit 60 is omitted, the outer side auxiliary sliding surface 106d of the driving shoe 100 corresponds to the “first sliding surface”. Note that when the inner side sliding surface 87a of the guide unit 60 is omitted, the shape of the outer side auxiliary sliding surface 106d of the driving shoe 100 is preferably appropriately changed.
Likewise, the outer side sliding surface 106i of the driving shoe 100 and the inner side auxiliary sliding surface 86b of the guide unit 60 are constituent elements to cause the check 250 to rotate from the release position to the engagement position by the driving shoe 100 sliding with the check 250 when moving forward. Thus, one of the outer side sliding surface 106i of the driving shoe 100 and the inner side auxiliary sliding surface 86b of the guide unit 60 can be omitted. When, for example, the outer side sliding surface 106i of the driving shoe 100 is omitted, the inner side auxiliary sliding surface 86b of the guide unit 60 corresponds to the “second sliding surface”. Note that when the outer side sliding surface 106i of the driving shoe 100 is omitted, the shape of the inner side auxiliary sliding surface 86b of the guide unit 60 is preferably appropriately changed.
In the sunroof device 30, the inner side front guides 80 and the outer side front guides 90 can be omitted. In this case, each of the guide rails 70 preferably includes constituent elements equivalent to the inner side restricting surface 86a, the inner side auxiliary sliding surface 86b, and the inner side clamping surfaces 86c and 87b of the corresponding inner side front guide 80.
The inner side clamping surfaces 86c and 87b of the inner side front guide 80 can be omitted. In this case, the sunroof device 30 preferably separately includes a structure to prevent the posture of each of the rear support portions 150 from changing when the corresponding driving shoes 100 moves between the tilt-up corresponding position and the full-open corresponding position.
The outer side engaging wall 106 of the driving shoe 100 includes a plurality of surfaces each of which presses the check 250 or slides with the check 250. When the driving shoe 100 moves in the front-rear direction, a surface that comes into contact with the check 250 changes from a surface to another among the plurality of surfaces of the outer side engaging wall 106 of the driving shoe 100. Thus, inclinations and the like of the plurality of surfaces of the outer side engaging wall 106 of the driving shoe 100 are preferably set in such a way that no abnormal noise or resistance is generated. For example, the plurality of surfaces of the outer side engaging wall 106 of the driving shoe 100 may be a curved surface. The same applies to a plurality of surfaces of the inner side front guide 80.
The rotation restricting portion 260 does not have to restrict the rotation of the check 250 by surface contact. For example, the rotation restricting portion 260 may restrict the rotation of the check 250 by point contact or line contact. The same applies to the first outer side restricting surface 106c of the driving shoe 100.
The rotation restricting portion 260 may restrict the rotation of the check 250 in another form. For example, it may be configured such that not only is the check 250 formed of a magnetic material but also the rotation of the check 250 is restricted using magnetic force.
The holding portion 262 of the rotation restricting portion 260 does not have to come into contact with the outer side upper surface 253c of the check 250 as long as the rotation restricting portion 260 can restrict the rotation of the check 250. For example, the holding portion 262 of the rotation restricting portion 260 may restrict the rotation of the check 250 by coming into contact with the inner side lower surface 252d of the check 250. In this case, the holding portion 262 of the rotation restricting portion 260 is preferably located between the bottom wall 71 of the guide rail 70 and the inner side lower surface 252d of the check 250 when restricting the rotation of the check 250.
The biasing member 272 does not have to be a coil spring as long as the biasing member 272 can bias the rotation restricting portion 260. For example, the biasing member 272 is only required to be an elastic body.
One of the inner side sliding surface 87a and the outer side sliding surface 106i that serve as constituent elements causing the check 250 to rotate can be omitted. For example, when the inner side sliding surface 87a of the guide unit 60 is omitted, the sunroof device 30 preferably includes biasing members each of which biases the corresponding check 250 toward the release position. According to this configuration, when the driving shoe 100 moves rearward toward the tilt-up corresponding position, the check 250 rotates toward the release position by biasing force of the biasing member. On the other hand, when the driving shoe 100 moves forward from the tilt-up corresponding position, the check 250 rotates toward the engagement position by sliding with the outer side sliding surface 106i of the driving shoe 100. Examples of the biasing member include a spring or a magnet. In addition, when the inner side sliding surface 87a of the guide unit 60 is omitted, the rotation restricting portion 260 can be omitted.
The first inner side engaging wall 86 and the rotation restricting portion 260 that serve as constituent elements restricting the rotation of the check 250 can be omitted. In this case, it may be configured such that by reducing a difference between outer diameter of the first shaft portion 231 of the check rod 210 and outer diameter of the support hole 254 of the check 250, the check 250 rotates only when sufficient torque is exerted on the check 250. In addition, when one of the first inner side engaging wall 86 and the rotation restricting portion 260 is omitted, the check 250 may be biased in a corresponding rotational direction by a biasing member, as described above.
In the movable panel 40, each of the front brackets 42 and a corresponding one of the rear brackets 43 may be connected to each other in the front-rear direction. In other words, the front bracket 42 and the rear bracket 43 may be integrally formed.
The forward direction and the rearward direction of the sunroof device 30 do not have to coincide with the forward direction and the rearward direction of the vehicle 10. For example, not only may the forward direction of the sunroof device 30 be the rearward direction of the vehicle 10 but also the rearward direction of the sunroof device 30 may be the forward direction of the vehicle 10.

### Supplementary Notes

Technological concepts that can be understood from the embodiment and modifications described above are described.

### [Aspect 1]

A sunroof device including: a movable panel that operates among a full-close position at which a roof opening portion of a vehicle is fully closed, a tilt-up position at which a rear end portion ascends higher than at the full-close position, and a full-open position that is a position located on a rear side of the tilt-up position and at which the roof opening portion is fully opened; a guide unit that extends in a front-rear direction; a front support portion that supports the movable panel; a rear support portion that supports the movable panel on a rear side of the front support portion; a driving shoe that, by moving along the guide unit, drives the front support portion and the rear support portion; and a power transmission member that, when the movable panel operates between the full-close position and the tilt-up position, transmits power from the driving shoe to the rear support portion and, when the movable panel operates between the tilt-up position and the full-open position, does not transmit power from the driving shoe to the rear support portion, wherein the movable panel performs, when the driving shoe moves rearward, an opening operation from the full-close position to the full-open position via the tilt-up position and performs, when the driving shoe moves forward, a closing operation from the full-open position to the full-close position via the tilt-up position, the front support portion causes the movable panel to move in the front-rear direction, based on power to be transmitted from the driving shoe, the rear support portion causes, by causing a rear end portion of the movable panel to ascend or descend based on power to be transmitted from the driving shoe via the power transmission member, the movable panel to operate between the full-close position and the tilt-up position, the power transmission member includes a check that rotates about an axis extending in a long-side direction of the guide unit, between an engagement position at which power can be transmitted from the driving shoe to the rear support portion and a release position at which power cannot be transmitted from the driving shoe to the rear support portion, and, when a position of the driving shoe when the movable panel is located at the tilt-up position is defined as a tilt-up corresponding position, at least one of the guide unit and the driving shoe includes a sliding surface that causes the check to rotate from one position of the engagement position and the release position toward another position by sliding with the check when the driving shoe moves rearward toward the tilt-up corresponding position or when the driving shoe moves forward from the tilt-up corresponding position.

### [Aspect 2]

The sunroof device according to Aspect 1, wherein the sliding surface includes a first sliding surface that causes the check to rotate from the engagement position toward the release position by sliding with the check when the driving shoe moves rearward toward the tilt-up corresponding position, and a second sliding surface that causes the check to rotate from the release position toward the engagement position by sliding with the check when the driving shoe moves forward from the tilt-up corresponding position.

### [Aspect 3]

The sunroof device according to Aspect 1 or 2, wherein the power transmission member includes a first restricting portion that, when the driving shoe is located on a rear side of the tilt-up corresponding position, restricts the check from rotating from the release position toward the engagement position.

### [Aspect 4]

The sunroof device according to Aspect 1 or 2, wherein the guide unit includes a second restricting portion that, when the driving shoe is located on a front side of the tilt-up corresponding position, restricts the check from rotating from the engagement position toward the release position.

### [Aspect 5]

The sunroof device according to Aspect 3, wherein the power transmission member includes a check rod that extends along the guide unit, the check rod supports the check in a rotatable manner and also supports the first restricting portion in a movable manner in a long-side direction of the check rod, and the first restricting portion is displaced between a rotation restricting position at which the first restricting portion restricts the check located at the release position from rotating and a rotation allowing position at which the first restricting portion allows the check to rotate.

### [Aspect 6]

The sunroof device according to Aspect 5, wherein the first restricting portion includes a first front restricting surface that restricts, by coming into contact with the check, the check from rotating from the release position toward the engagement position, the driving shoe includes a first rear restricting surface that restricts, by coming into contact with the check, the check from rotating from the release position toward the engagement position, a state in which only the first rear restricting surface comes into contact with the check transitions to a state in which only the first front restricting surface comes into contact with the check via a state in which both the first rear restricting surface and the first front restricting surface come into contact with the check, when the driving shoe moves rearward from the tilt-up corresponding position, and, a state in which only the first front restricting surface comes into contact with the check transitions to a state in which only the first rear restricting surface comes into contact with the check via a state in which both the first front restricting surface and the first rear restricting surface come into contact with the check, when the driving shoe moves forward toward the tilt-up corresponding position.

### [Aspect 7]

The sunroof device according to Aspect 5 or 6, wherein the power transmission member includes a biasing member that biases the first restricting portion from the rotation allowing position toward the rotation restricting position, and the first restricting portion is, when the driving shoe moves forward, displaced toward the rotation allowing position by being pressed by the driving shoe, and on the other hand, when the driving shoe moves rearward, displaced toward the rotation restricting position by being biased by the biasing member.

### [Aspect 8]

The sunroof device according to any one of Aspects 1 to 7, wherein the guide unit includes a clamping portion that, when the driving shoe is located on a rear side of the tilt-up corresponding position, clamps the check in the front-rear direction.

### [Aspect 9]

The sunroof device according to any one of Aspects 2 to 8, wherein the guide unit includes the first sliding surface, and the driving shoe includes the second sliding surface.

### [Aspect 10]

The sunroof device according to Aspect 9, wherein the driving shoe includes a first auxiliary sliding surface that causes the check to rotate toward the release position by sliding with the check when the driving shoe moves rearward toward the tilt-up corresponding position, the guide unit includes a second auxiliary sliding surface that causes the check to rotate toward the engagement position by sliding with the check when the driving shoe moves forward from the tilt-up corresponding position, and the check rotates, when the driving shoe moves rearward toward the tilt-up corresponding position, to the release position by sliding with the first sliding surface and subsequently sliding with the first auxiliary sliding surface, and rotates, when the driving shoe moves forward from the tilt-up corresponding position, to the engagement position by sliding with the second sliding surface and subsequently sliding with the second auxiliary sliding surface.

The sunroof device includes a check that changes a status of power transmission from the driving shoe to the rear support portion. The check rotates between the engagement position at which power can be transmitted from the driving shoe to the rear support portion and the release position at which power cannot be transmitted from the driving shoe to the rear support portion. Specifically, in respect that the check does not largely move in the up-down direction between the engagement position and the release position, thickness in the up-down direction of the sunroof device can be prevented from increasing. Further, when the driving shoe moves rearward toward the tilt-up corresponding position, the check rotates to the release position by sliding with a sliding surface. Alternatively, when the driving shoe moves forward from the tilt-up corresponding position, the check rotates to the engagement position by sliding with the sliding surface. Thus, the sunroof device can change a position of the check according to movement of the driving shoe.

The sunroof device enables thickness in the up-down direction to be prevented from increasing due to the check.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A sunroof device comprising:
a movable panel that operates among a full-close position at which a roof opening portion of a vehicle is fully closed, a tilt-up position at which a rear end portion ascends higher than at the full-close position, and a full-open position that is a position located on a rear side of the tilt-up position and at which the roof opening portion is fully opened;
a guide unit that extends in a front-rear direction;
a front support portion that supports the movable panel;
a rear support portion that supports the movable panel on a rear side of the front support portion;
a driving shoe that drives, by moving along the guide unit, the front support portion and the rear support portion; and
a power transmission member that transmits, when the movable panel operates between the full-close position and the tilt-up position, power from the driving shoe to the rear support portion, and, when the movable panel operates between the tilt-up position and the full-open position, does not transmit power from the driving shoe to the rear support portion, wherein
the movable panel performs, when the driving shoe moves rearward, an opening operation from the full-close position to the full-open position via the tilt-up position, and performs, when the driving shoe moves forward, a closing operation from the full-open position to the full-close position via the tilt-up position,
the front support portion causes the movable panel to move in the front-rear direction, based on power to be transmitted from the driving shoe,
the rear support portion causes, by causing a rear end portion of the movable panel to ascend or descend based on power to be transmitted from the driving shoe via the power transmission member, the movable panel to operate between the full-close position and the tilt-up position,
the power transmission member includes a check that rotates about an axis extending in a long-side direction of the guide unit between an engagement position at which power can be transmitted from the driving shoe to the rear support portion and a release position at which power cannot be transmitted from the driving shoe to the rear support portion, and,
when a position of the driving shoe when the movable panel is located at the tilt-up position is defined as a tilt-up corresponding position,
at least one of the guide unit and the driving shoe includes a sliding surface that causes the check to rotate from one position of the engagement position and the release position toward another position by sliding with the check when the driving shoe moves rearward toward the tilt-up corresponding position or when the driving shoe moves forward from the tilt-up corresponding position.

2. The sunroof device according to claim 1, wherein the sliding surface includes a first sliding surface that causes the check to rotate from the engagement position toward the release position by sliding with the check when the driving shoe moves rearward toward the tilt-up corresponding position, and a second sliding surface that causes the check to rotate from the release position toward the engagement position by sliding with the check when the driving shoe moves forward from the tilt-up corresponding position.

3. The sunroof device according to claim 1, wherein the power transmission member includes a first restricting portion that restricts, when the driving shoe is located on a rear side of the tilt-up corresponding position, the check from rotating from the release position toward the engagement position.

4. The sunroof device according to claim 1, wherein the guide unit includes a second restricting portion that restricts, when the driving shoe is located on a front side of the tilt-up corresponding position, the check from rotating from the engagement position toward the release position.

5. The sunroof device according to claim 3, wherein
the power transmission member includes a check rod that extends along the guide unit,
the check rod supports the check in a rotatable manner and also supports the first restricting portion in a movable manner in a long-side direction of the check rod, and
the first restricting portion is displaced between a rotation restricting position at which the first restricting portion restricts the check located at the release position from rotating and a rotation allowing position at which the first restricting portion allows the check to rotate.

6. The sunroof device according to claim 5, wherein
the first restricting portion includes a first front restricting surface that restricts, by coming into contact with the check, the check from rotating from the release position toward the engagement position,
the driving shoe includes a first rear restricting surface that restricts, by coming into contact with the check, the check from rotating from the release position toward the engagement position,
a state in which only the first rear restricting surface comes into contact with the check transitions to a state in which only the first front restricting surface comes into contact with the check via a state in which both the first rear restricting surface and the first front restricting surface come into contact with the check when the driving shoe moves rearward from the tilt-up corresponding position, and
a state in which only the first front restricting surface comes into contact with the check transitions to a state in which only the first rear restricting surface comes into contact with the check via a state in which both the first front restricting surface and the first rear restricting surface come into contact with the check when the driving shoe moves forward toward the tilt-up corresponding position.

7. The sunroof device according to claim 6, wherein
the power transmission member includes a biasing member that biases the first restricting portion from the rotation allowing position toward the rotation restricting position, and
the first restricting portion is, when the driving shoe moves forward, displaced toward the rotation allowing position by being pressed by the driving shoe, and on the other hand, when the driving shoe moves rearward, displaced toward the rotation restricting position by being biased by the biasing member.

8. The sunroof device according to claim 1, wherein the guide unit includes a clamping portion that clamps, when the driving shoe is located on a rear side of the tilt-up corresponding position, the check in the front-rear direction.

9. The sunroof device according to claim 2, wherein
the guide unit includes the first sliding surface, and
the driving shoe includes the second sliding surface.

10. The sunroof device according to claim 9, wherein
the driving shoe includes a first auxiliary sliding surface that causes the check to rotate toward the release position by sliding with the check when the driving shoe moves rearward toward the tilt-up corresponding position,
the guide unit includes a second auxiliary sliding surface that causes the check to rotate toward the engagement position by sliding with the check when the driving shoe moves forward from the tilt-up corresponding position, and
the check rotates, when the driving shoe moves rearward toward the tilt-up corresponding position, to the release position by sliding with the first sliding surface and subsequently sliding with the first auxiliary sliding surface, and rotates, when the driving shoe moves forward from the tilt-up corresponding position, to the engagement position by sliding with the second sliding surface and subsequently sliding with the second auxiliary sliding surface.

11. The sunroof device according to claim 2, wherein the power transmission member includes a first restricting portion that restricts, when the driving shoe is located on a rear side of the tilt-up corresponding position, the check from rotating from the release position toward the engagement position.

12. The sunroof device according to claim 11, wherein
the power transmission member includes a check rod that extends along the guide unit,
the check rod supports the check in a rotatable manner and also supports the first restricting portion in a movable manner in a long-side direction of the check rod, and
the first restricting portion is displaced between a rotation restricting position at which the first restricting portion restricts the check located at the release position from rotating and a rotation allowing position at which the first restricting portion allows the check to rotate.

13. The sunroof device according to claim 12, wherein
the first restricting portion includes a first front restricting surface that restricts, by coming into contact with the check, the check from rotating from the release position toward the engagement position,
the driving shoe includes a first rear restricting surface that restricts, by coming into contact with the check, the check from rotating from the release position toward the engagement position,
a state in which only the first rear restricting surface comes into contact with the check transitions to a state in which only the first front restricting surface comes into contact with the check via a state in which both the first rear restricting surface and the first front restricting surface come into contact with the check when the driving shoe moves rearward from the tilt-up corresponding position, and
a state in which only the first front restricting surface comes into contact with the check transitions to a state in which only the first rear restricting surface comes into contact with the check via a state in which both the first front restricting surface and the first rear restricting surface come into contact with the check when the driving shoe moves forward toward the tilt-up corresponding position.

14. The sunroof device according to claim 13, wherein
the power transmission member includes a biasing member that biases the first restricting portion from the rotation allowing position toward the rotation restricting position, and
the first restricting portion is, when the driving shoe moves forward, displaced toward the rotation allowing position by being pressed by the driving shoe, and on the other hand, when the driving shoe moves rearward, displaced toward the rotation restricting position by being biased by the biasing member.

15. The sunroof device according to claim 2, wherein the guide unit includes a second restricting portion that restricts, when the driving shoe is located on a front side of the tilt-up corresponding position, the check from rotating from the engagement position toward the release position.

16. The sunroof device according to claim 2, wherein the guide unit includes a clamping portion that clamps, when the driving shoe is located on a rear side of the tilt-up corresponding position, the check in the front-rear direction.
